(19) United States
(12) Patent Application Publication
(10) Pub. No.: US 2005/0109879 A1
(43) Pub. Date: May 26, 2005

(54) Method and apparatus for quantum vortex implosion propulsion and species

(76) Inventor: Robert A. Patterson, Wapanucka, OK (US)

Correspondence Address: Robert A. Patterson, Blue Springs Rd Rt-1, Box 66-A, Wapanucka, OK, 73461, US

(21) Appl. No.: 10/719,717

(22) Filed: Nov. 21, 2003

(51) Int. Cl. F02K 1/00; F03H 1/00

(52) U.S. Cl. 244/172

(57) ABSTRACT

System for converting high frequency quantum electrodynamic radiation energy and at least one atom through cavity vacuum fluctuations and converting same into a superconductive electrical implosion propulsion energy from zero point energy at a frequency that is amenable to conversion to electrical and implosive propulsion and superconductive energy extracted within an environment having a desired voltage and a reversed waveform such that the emitted energy returns into the system to be recycled. In an externally winged craft comprising a selectively shaped vacuum cohesive fuselage and means for providing lift and propulsion for an aircraft generating an enormous electrostatic vortex lifting force when energized in conjunction with the quantum electrodynamic vortex implosion propulsion system and power plant maximizing fuel efficiencies including the extraction of usable energy from the vacuum of space. Actually riding on or in the shock waves verses the brute force disruption of the environment's equilibrium, as is the case with conventional modes of transportation or aircraft design.

### BACKGROUND OF THE INVENTION

The vacuum of space contains enormous residual background energy with densities estimated to be on the order of nuclear energy densities. Zero point energy was predicted by quantum theory and verified via experimentation and is known to play a role in large-scale phenomena of interest, including, aerodynamic and/or fluid mechanics, renewable superconductive energy, holographic optical communication technologies. Linear spectral filtering which offers unique potential for future high-bandwidth communication systems. Inhibition of spontaneous emission, the generation of short-range attractive forces (e.g., the Casimir force.) Topics of interest range from space-flight applications to fundamental issues of renewable energy sources to cavity Quantum Electrodynamics (QED) laboratory attempts extracting useful energy from vacuum fluctuations thereby verifying environmental energy may indeed be extracted for practical use.

Selectively engineered shapes may convey energy via high and low-pressure differentials with emphasis on convergence zones, i.e., when high pressure air flips from underneath a wings surface over onto the upper section of the wing where low pressures abound whereby a vortex is formed via the high and low pressure convergence of two opposing forces FIGS. 17, 18, 19, 20, 21, and 22.

Physicist M. J. Sparnaay discovered the existence of zero point electromagnetic radiation in 1958 continued experimentation carried out by Hendrik B. G. Casimir in 1948, showed the existence of a force between two uncharged parallel plates, which arose from electromagnetic radiation surrounding the plates in a vacuum. Mr. Sparnaay discovered that the forces acting on the plates arose from both thermal radiation and another type of radiation now known as zero point radiation.

Because zero point radiation exists in a vacuum it is homogeneous, isotropic and ubiquitous. In addition, zero point radiation is invariant with respect to Lorentz transformation; the zero point radiation spectrums have the characteristic that the intensity of the radiation at any frequency is proportional to the cube of that frequency.

Consequently, the intensity of the radiation increases without limit as the frequency increases resulting in an infinite energy density for the radiation spectrum. Special characteristics of the zero point radiation, is it has a virtually infinite energy density and that it is ubiquitous (present in outer space) make it very desirable as an energy source.

However, because high energy densities exist at very high radiation frequencies and because conventional methods are only able to convert or extract energy effectively or efficiently only at lower frequencies at which zero point radiation has relatively low energy densities, effectively tapping this energy source has been believed to be unavailable using conventional techniques for converting electromagnetic energy to electrical or other forms of easily useable energy. Consequently, zero point electromagnetic radiation energy which may potentially be used to power interplanetary craft as well as provide for society's other needs has remained until now an untapped renewable energy source.

There are many types of prior art systems that use a plurality of antennas to receive electromagnetic radiation and provide an electrical output therefrom. An example of such a prior art system is disclosed in U.S. Pat. No. 5,590,031 Mead, Jr. Dec. 31, 1996. The Mead system utilizes a plurality of dielectric antenna structures which work in tandem and which oscillate by means of volumetric sizing thereto in order to modulate the radiation reflected from the antenna surfaces. A distance equal to a quarter wavelength of the incident radiation also separates the reflecting surfaces of the antennas. However, while the Mead system does convert the incident radiation to electrical current it falls short of any type of re-amplification system for the purpose of converting the incident electromagnetic radiation to electrical energy to another form of readily useable energy or propulsion force. In addition, this lack of a re-amplification system of the Mead system components renders it unable to resonate at and modulate vortex implosion propulsion.

Therefore a system is needed which is capable of converting high frequency electromagnetic radiation energy into another form of energy which can be more readily used to provide power for transportation, heating, cooling as well as various other needs of society. What is also needed is such a system that may be used to provide energy from any location on earth or in space.

1. Field of the Invention

This invention relates to improvements in aircraft incorporating vortex chamber swirl-vane-designs, mixing of radial and tangential flows and more particularly but not by way of limitation, to means for providing lift and propulsion for aircraft, extracting usable energy from the environment through vortex, action, air passing through an hyperbolic chamber, vortex convergence and swirl zone. Said suction-head or vortex flow gives rise to higher-pressure differential gradients of either-or high or low pressures forming a vacuum so that the pressure difference provides lift and propulsion for the aircraft.

From the mechanical and geometrical points of view, the invention or aircraft designed and/or otherwise built as a usual or conventional airplane-glider will give rise to long running flight times, limited to landing only by the pilots needs, otherwise describing the human condition. By virtue of the invention's selective shape and interaction with nature said invention becomes a no moving part motor.

From the electronic point of view, the aforementioned invention may be thought of as a no moving part motor, analogized as an electric motor wherein the invention becomes the stator and thus the air becomes the rotor thereby meeting the definition and criteria consistent with the description of a motor.

2. Description of the Prior Art

Cavity QED may be loosely described as the study of atom-field dynamics in the presence of boundaries said boundaries collectively constituting a cavity and are significant in that they perturb the spatial and/or spectral structure and distribution of electromagnetic field modes relative to the free-space norm, thereby opening the door to new and unique phenomenology. Since both propagation and radiation phenomena co-exist in open guides, they are common in practice but hard to understand theoretically.

Standard classical optical design procedures along with the intuitive concept of hour-glass-type optical modes are employed to produce cavities that provide strong atom-cavity coupling for Atoms that are spread over a relatively large spatial region. Such cavities may be employed to provide macroscopic environments in which ordinarily microscopic quantum optical phenomena play an essential role. Recent research advances into the physics of optical cavity QED underlying vacuum pumping, Rabi splitting reveals the indications of potential applications made possible in all these areas of interest. Key factors to the realization of these potential technologies are the development of robust, cost-effective and fully integrated filtering devices derived from the unique properties of optical atom-coupled waveguide technologies.

A wide range of physical systems fall within the scope of cavity QED. At one extreme, we have an isolated atom interacting with a single undampened field mode. More realistically, systems may consist of atoms and field modes, all of which experience damping due to the interaction with one or more reservoir. Many physical models have been considered and numerous categories of cavity QED phenomena have been identified. Phenomena that are specifically identified with cavity QED tend to appear in the regime of strong atom-cavity coupling i.e., when the interaction of an atom with a single cavity photon becomes important.

For the most part, experimenters have worked with one basic cavity parameter in their efforts to realize strong atom-cavity coupling, the overall cavity mode volume. Through minimization of this parameter, relatively strong atom-cavity coupling has been realized in both the optical and microwave regimes.

Cavity mode volume does not, however, tell the whole story. Strong atom-cavity coupling has, for example, been demonstrated in large cm-scale optical cavities and attributed to the combination effect of many spectrally degenerate large-volume modes. It should be noted that optical design methods can-be employed to create macroscopic environments wherein normally microscopic quantum optical phenomena play an essential role.

In 1946, Purcell predicted that the spontaneous emission rate of an atom located in a cavity tuned to the atomic-transition frequency would be subsequently larger than in free space. The enhancement results from a cavity-induced increase in photon-mode density at the atomic-transition frequency. Following this idea, Kleppner predicted that the opposite effect i.e., suppression of spontaneous emission, occurs if a cavity is employed to reduce the density of a photon modes in the spectral region of the atomic transition.

In fact, Kleppner predicted that spontaneous-emission could be eliminated altogether by placing an atom in a waveguide below cut off. Kleppner's paper stimulated a series of experimental works on the subject in both microwave and optical regimes. In most of the experiments the dimension of the cavity was comparable to the wavelength. Heinzen showed that analogous effects could be observed in con-focal cavities of large dimensions, i.e., by imposing a strong driving field on the atoms. In order for such a dynamic effect to occur, the atoms must reside in a region of space in which the density of photon modes varies appreciably on a frequency scale set by the Rabi frequency of the driving field.

Cavities provide a natural setting for frequency-dependent mode densities but they may also arise in diverse environments, including those involving the solid-state thereby emphasizing the effect of strong driving fields on spontaneous-emission rates in this particular situation the irradiated atom is within a cavity. Resonance-fluorescence spectra have been analyzed and shown to poses features indicative of dynamic modifications of spontaneous emission.

New insights into the statistical properties of the quantum electromagnetic field in cavities has been achieved with the discovery of vacuum Rabi splitting which can be considered as another type of modification of the spontaneous-emission process. In the regime, where the cavity width becomes comparable or smaller than the atomic spontaneous emission rate the resonance-fluorescence spectral consists of two separate peaks. The splitting reflects the splitting of the lowest excited energy levels and may-be observed when light is transmitted through an atom-containing cavity, which will under-go substantial relative squeezing.

Placing atoms inside an optical cavity can create composite atom-cavity systems. The behavior of such coupled system can often be more complex and thus richer than that of either the atoms or the cavity when considered separately. The properties of such atom-cavity systems are important because they play a vital role in the analysis and the effects of such optical coupled quantum fluctuations.

It has been predicted that the insertion of a single atom into a cavity can lead to a splitting in the atomic fluorescence spectra when the atom is strongly coupled to the cavity. The splitting termed the vacuum Rabi splitting has attracted the attention of the quantum optics community because it is considered to be an important manifestation of the quantum nature of the electromagnetic field.

In the optical regime experimental confirmation of the single-atom vacuum Rabi splitting has been precluded by the smallish size of the coupling between the atom and the cavity. Fortunately, it has been shown that the cavity resonance splitting also occurs when many atoms are inserted into a cavity and that the magnitude of the splitting increases with the square root of the number of atoms inserted. Multi-atom enhancement has been employed successfully in an effort to observe vacuum Rabi splitting. From the perspective of quantum optics the vacuum Rabi splitting may be seen to follow from the exchange of excitation back and forth between the atoms in the cavity field. In the transient regime this exchange is manifest as a temporal oscillation on the light transmitted through the cavity from the classical perspective the atom cavity system is a simple linear system and the time and frequency domain responses of the system are connected via Fourier transformation.

The influence of environment on spontaneous radiative decay properties has attracted considerable attention in recent years it has been predicted that cavity confined atoms may experience an inhibition of spontaneous emission because of cavity-induced reduction in resonant electromagnetic-mode density. The voracity of this prediction has been demonstrated by experiments in the microwave, infrared, and optical regimes. The opposite effect in which the spontaneous decay rate is enhanced over free space value is because of the cavity-induced increase in mode density. These results have stimulated a number of theoretical works related to modify spontaneous emission under various special circumstances.

Entirely new phenomenon including dynamic suppression of spontaneous emission dressed-state pumping atomic squeezing have been predicted to occur in cases were the vacuum reservoir is frequency dependent on a scale comparable to or finer than the atomic resonance width [Spectral and statistical properties of strongly driven atoms coupled to frequency-dependent photon reservoirs, M. Lewenstein and T. W. Mossberg, Phys. Rev. A 37, 2048 (1988). Phys. Rev. A 38, 808 (1988). Phys. Rev. A 38, 1075 (1988). Phys. Rev. Lett. 61, 1946 (1988). Phys. Rev. A (Rapid Communication) 39, 2754 (1989)].

As set forth within the elements of Aerofoil and Airscrew theory an aircraft's wing is designed with a plane of symmetry passing through its mid-point of span, and the direction of relative motion to the plane of resultant action in said plane.

Generally speaking, a common practice is to shape the wings of an aircraft so that the velocity of air streaming over the top or upper most surface of each wing is greater than the velocity of air streaming over the bottom or lower most or under surface of the wing. This velocity differential achieved by the contour of the wing, results in a pressure differential across the wing so that a net force, lift, is exerted on the wing to support the aircraft in flight.

Cord-line of an airfoil is defined as the line joining the centers of curvature for the leading and trailing edges and the projection of the airfoil section on this line is defined as the chord length. An airfoil's angle of incidence is defined as the angle between the chord and the direction of motion relative to the fluid through which the body is moving. An airfoil's center of pressure is defined as the point in which the line of action of the resultant force intersects the chord. Said resultant force is resolved into two components, lift, at right angles to the direction of motion and drag parallel to the direction of the craft although opposing the forward motion of the craft.

A common design flaw inherent within all aircraft of usual design is the aircraft's own geometrical shape design. That is any wing that deviates form the one hundred present efficient elliptical wing shape assumed 100% efficient for purpose of comparison. Wherein the shock wave of parasitic drag is considered unavoidable and a price requiring payment in excessive fuel consumption wrought by incorrectly designed cantilevered wings disposed out from the aircraft's body ending with tapered wing tips.

Thereby decreasing the relative efficiencies of basic wing plane-forms with each wing inductively inducing parasitic drag according to the wings own geometrical deviation from the perfect ellipsoidal plane-form.

Experimentation has greatly improved aircraft design, achieving greater flight performance as well as economic efficiencies of operation and construction methods thereof, yet to-date many problems exist within the industry.

Since the primary shock waves created by an airplane's wings cannot be avoided, the key to solving sonic problems clearly lies in wing design. Shock waves cannot be prevented but their effects can be reduced by several means making the wings thinner, sharper leading edges; shorter and wider designs sweeping them forward taking advantage of the shock wave or shaping the wing rearward in avoidance of said shock wave.

Unfortunately, the more tapered or swept back the wing becomes the more adversely the wing becomes affected by parasitic shock waves sapping the aircraft's momentum and consuming excessive amounts of fuel conversely an ellipsoidal shaped wing is 100% co-efficient.

Several combinations of these principles have been built into all modern high-speed aircraft. But all designs are at best compromises; some high-speed capabilities have to be sacrificed to enable the aircraft to be operative at low speeds e.g., take off and landing. This difficulty has been tackled with variable-sweep wings combining the best of both worlds for high-speed operation the wings can be angled in mid-flight, a drawback of the system is the complex equipment needed to move the wings.

In order to reduce supersonic wave drag further engineers need to study the wings and fuselage as a unit presented to the on-rushing air. Interestingly they found it important that the areas of consecutive cross-section of the plane, increasing from the nose and decreasing towards the tail, should add up to the smallest possible curve. Under this theory, called the “area rule” the perfect shape would be an egg but the necessity for wings forces compromise. Therefore results will be significant not only for the performance but also for the look of supersonic aircraft and beyond.

Paying particular attention to a design theory called the “compression lift rule” The basic idea here is that surfaces can be so arranged that shock waves will actually reinforce one another to provide lift, as in a planning speedboat or a rock when skipped across a pool of water. Because shock waves so severely affect an airplane's stability, the greatest problem for a pilot at the sound barrier is the changing control characteristics. A wing has a slowly moving layer of air called the “boundary layer” that clings to its surface.

Near Mach 1 shock waves can interact with the boundary layer to distort the airflow so that lift may be impaired and control surfaces rendered ineffectual. This disturbance also adds to the turbulent wake, which is created by any conventional wing, whatever its speed. Therefore “wing-shape” and “surface-texture” is obviously important to the strategic control of airflow.

Vacuum Energy

An approach based on a 1987 paper by H. E. Puthoff, Ph.D. utilizing micro-gravity techniques to perturb the ground state stability of atomic hydrogen in which he puts forth the hypothesis “That the nonradiative nature of the ground state is due to a dynamic equilibrium in which radiation emitted due to accelerated electron ground state motion is compensated by absorption from the ZPE” (zero point energy). If this hypothesis is true, there exists the potential for energy generation by the application of the techniques of cavity QED. In cavity QED, excited atoms are passed through Casimir-like cavities whose structure suppresses electromagnetic cavity modes at the transition frequency between the atom's excited and ground states. With the introduction of the zero point radiation a vacuum at absolute zero is no longer considered empty. Instead, the vacuum is now considered as filled with randomly fluctuating fields having the zero point radiation spectrums. Special characteristics of ZPE that make it very desirable as an energy source is that it has a near infinite energy density it is ubiquitous (i.e., present in outer space).

Concept of vacuum energy is satisfactorily explained by the diffusion of energy, similar to blowing a bubble under water, which in turn rises to the surface seeking its own equilibrium. Is a view of a means for encapsulating the aircraft in a higher state of vacuum energy that is, V-shaped grooves called Riblets. These grooves inhibit the motion of eddies by preventing them from coming very close to the surface of a wing these V-shaped grooves prevent eddies from transporting high-speed fluid close to the surface where it decelerates and saps the aircraft's momentum. These and other concepts are being applied by NASA at the Langley Research Center, which demonstrated that use of the V-shaped grooves leads to a 5 to 6 percent reduction of viscous drag.

To be effective, the Riblets must be very closely spaced, like phonograph grooves on a record. It would seem that nature endorses this concept, the skin of a shark has tiny tooth-like denticles called “photomicrographs” that serve the same function as the Riblets, lessening the drag on the shark as it moves through the water Scientific American, January 1997, Tackling turbulence with supercomputers by Parviz Moin and John Kim pages 62-68].

Gravity and Inertia

Haisch, Rueda and H. E. Puthoff, Ph.D. addressed the Inertia issue in a 1994 paper entitled “Inertia as a Zero-Point Field Lorentz Force,” of inertia and associated it with Mach's Principle and the properties of the vacuum. It turns out that the quantum fluctuations of distant matter, (i.e., stars) structure the local-vacuum fluctuation-frame of reference. The implication for space travel is this: Given the evidence generated in the field of Cavity QED (discussed above), there is experimental evidence that vacuum fluctuations can be altered by technological means. Logic infers that in principle, gravitational and inertial masses may also be altered.

Quantum theory teaches us that empty space is not truly empty, but rather that it is a plenum filled with an (energetic quantum process). A process possessing profound implications for future communication systems, space travel, i.e. the selective design geometry/shape of future spacecraft endowed with the ability to interact directly with the vacuum. Thereby making it possible to extract and/or borrower energy from the environmental fields continuously fluctuating about their zero base-line values. Note: such activity remains even at absolute zero. Reflecting for a moment Einstein's general theory of relativity, forced to reverse his stand on space as a complete void and opt for a richly endowed plenum, named the space-time metrics.

Thomas Young's Double Slit Experiment

In 1801, an English physicist named Thomas Young performed an experiment, which explores how coherent light waves interact when passed through two closely spaced slits that strongly inferred the wave-like nature of light. Because he believed that light was composed of waves, Young reasoned that some type of interaction would occur when two light waves met.

Young's experiment was based on the hypothesis that if light were wave-like in nature, then it should behave in a manner similar to ripples or waves on a pond of water. Where two opposing water waves meet, they should react in a specific manner to either reinforce or destroy each other. If the two waves are in step (the crests meet), then they should combine to make a larger wave. In contrast, when two waves meet that are out of step (the crest of one meets the trough of another), the waves should cancel and produce a flat surface in that area.

In order to test his hypothesis, Young devised an ingenious experiment. Using sunlight diffracted through a small slit as a source of coherent illumination, he projected the light rays emanating from the slit onto another screen containing two slits placed side by side. Light passing through the slits was then allowed to fall onto a screen. Young observed that when the slits were large, spaced far apart and close to the screen, then two overlapping patches of light formed on the screen. However, when he reduced the size of the slits and brought them closer together, the light passing through the slits and onto the screen produced distinct bands of color separated by dark regions in a serial order. Young coined the term interference fringes to describe the bands and realized that these colored bands could only be produced if light were acting like a wave.

The success of Young's experiment was strong testimony in favor of the wave theory, but was not immediately accepted by his peers. The events in place behind phenomena such as the rainbow of colors observed in soap bubbles and Newton's rings (to be discussed below), although explained by this work, were not immediately obvious to those scientists who firmly believed that light propagated as a stream of particles. Other types of experiments were later devised and conducted to demonstrate the wave-like nature of light and interference effects. Most notable are the single mirror experiment of Humphrey Lloyd and the double mirror and bi-prism experiments devised by Augustin Fresnel for polarized light in uniaxial and birefringent crystals.

Fresnel concluded that interference between beams of polarized light could only be obtained with beams having the same polarization direction. In effect, polarized light waves having their vibration directions oriented parallel to each other can combine to produce interference, whereas those that are perpendicular do not interfere.

Resonator

A Resonator is defined as a condition in a circuit that converts energy from a potential form to a kinetic form. One example of a resonance in electronics is that of the L-C filter. As the capacitor discharges the inductor stores the energy, and as the inductor converts the magnetic energy into electrical energy, the capacitor charges up again. An oscilloscope can observe this action, with the resulting waveform having a distinct period. This repeating phenomenon is called a resonance. An Oscillator circuit is defined as “an electronic circuit that converts energy from a direct-current source into a periodically varying electrical output.” [Parker, 1984].

Therefore, an oscillator takes a steady state signal, and using electrical behaviors of circuit elements, converts the signal into a periodic, time variant signal. This oscillation can be sinusoidal in appearance (sine wave oscillation), square waved, triangular waved, or any variety of repeatable signals.

Superconductivity

Superconductivity, phenomenon displayed by certain conductors that demonstrate no resistance to the flow of an electric current. Superconductors also exhibit strong diamagnetism; that is, they are repelled by magnetic fields. Superconductivity is manifested only below a certain critical temperature Tc and a critical magnetic field Hc, which vary with the material used. Before 1986, the highest Tc was 23.2 K (−249.8° C./−417.6° F.) in niobium-germanium compounds. Temperatures this low were achieved by use of liquid helium, an expensive, inefficient coolant. Ultralow-temperature operation places a severe constraint on the overall efficiency of a superconducting machine. Thus, large-scale operation of such machines was not considered practical. But in 1986 discoveries at several universities and research centers began to radically alter this situation.

Ceramic metal-oxide compounds containing rare earth elements were found to be superconductive at temperatures high enough to permit using liquid nitrogen as a coolant. Because liquid nitrogen, at 77K (−196° C./−321° F.), cools 20 times more effectively than liquid helium and is 10 times less expensive, a host of potential applications suddenly began to hold the promise of economic feasibility. In 1987 the composition of one of these superconducting compounds, with Tc of 94K (−179° C./−290° F.), was revealed to be YBa2Cu307 (yttrium-barium-copper-oxide). It has since been shown that rare-earth elements, such as yttrium, are not an essential constituent, for in 1988 a thallium-barium-calcium copper oxide was discovered with a Tc of 125K (−148° C./−234° F.).

In comparing superconductor technology with present room temperature devices, the need for cooling cryogenic liquids and systems will still be needed and is a serious economic and technological disadvantage. There is a great difference between switching on a machine as needed and having to supply continuous refrigeration, or having to wait for refrigeration systems to reach operating temperatures.

Superconductivity was first discovered in 1911 by the Dutch physicist Heike Kamerlingh Onnes, who observed no electrical resistance in mercury below 4.2 K (−268.8° C./−451.8° F.) The phenomenon was better understood only after strong diamagnetism was detected in a superconductor by Karl W. Meissner and R. Ochsenfeld of Germany in 1933. The basic physics of superconductivity, however, was not realized until 1957, when the American physicists John Bardeen, Leon N. Cooper, and John R. Schrieffer advanced the now celebrated BCS theory, for which the three were awarded the 1972 Nobel Prize in physics. The theory describes superconductivity as a quantum phenomenon, which the conduction electrons move in pairs and thus show no electrical resistance. In 1962 the British physicist Brian D. Josephson examined the quantum nature of superconductivity and proposed the existence of oscillations in the electric current flowing through two superconductors separated by a thin insulating layer in a magnetic or electric field. The effect, known as the Josephson effect subsequently was confirmed by experiments.

Because of their lack of resistance, superconductors have been used to make electromagnets that generate large magnetic fields with no energy loss. Superconducting magnets have been used in diagnostic medical equipment, studies of materials, and in the construction of powerful particle accelerators. Using the quantum effects of superconductivity, devices have been developed that measure electric current, voltage, and magnetic field with unprecedented sensitivity.

The discovery of better superconducting compounds is a significant step toward a far wider spectrum of applications, including faster computers with larger storage capacities, nuclear fusion reactors in which ionized gas is confined by magnetic fields, magnetic levitation (lifting or suspension) of high-speed (“Maglev”) trains, and perhaps most important of all, more efficient generation and transmission of electric power. The 1987 Nobel Prize in physics went to West German physicist J. Georg Bednorz and Swiss physicist K. Alex Muller for their discovery of materials that are superconductive at temperatures higher than had been thought possible [Superconductor Technology: Applications to Microwave, Electro-Optics, Electrical Machines, and Propulsion Systems by A. R. Jha (Author) Publisher: Wiley-Interscience; 1 edition (Mar. 24, 1998) ISBN: 047117775X Author A. R. Jha].

Vortex Chambers

C. D. Pengelley published a simplified analysis of two-dimensional vortex fields in 1956. The calculations gave dimensionless pressure and temperature charts and included a numerical example for the two-dimensional vortex flow field. The purpose of the input element of a vortex pressure amplifier is to introduce swirl into the vortex chamber as a function of pressure input. As described above, the input element may be widely different for the various vortex devices: a single tangential orifice in vortex diodes, multiple nozzles located symmetrically to produce the balanced flow required in the Ranque-Hilsch Tube and Swirl Atomizers, and porous coupling elements in vortex inertial sensors to impart the small inertial rotation to the incoming fluid. In vortex valves and pressure amplifiers, the function of the input element includes the noise free mixing of a radial supply flow stream with the tangential control input.

The simplest design is the two port configuration, where the supply flow enters through a single tangential port mixing of the tangential momentum is accomplished efficiently and uniformly in the annular zone prior to entry into the vortex chamber as long as the annular zone allows free mixing of the control inputs, linear addition and subtraction of any number of pressure inputs is possible in the input elements of a vortex pressure amplifier.

In general, three basic rotational flow-fields may be encountered in a vortex chamber:

1. The solid body rotation or forced vortex flow occurs under high viscous coupling. At extreme tangential velocities the apparent viscosity in gases becomes large; values of the order of a thousand times the normal viscosity have been estimated in experimental reports on the Ranque-Hilsch Tube.

2. The free vortex rotation is defined by constant angular momentum. This mode of rotation may be observed in bodies of gases rotating at comparatively low velocities, when the effective viscosity becomes negligible.

3. Constant tangential velocity is a unique intermediate velocity distribution between the free vortex and forced vortex rotation. Tangential velocity profiles may be described for all conditions by simple exponential equations.

For specific velocity distributions, the value of n may be defined:
=−1 for free vortex velocity distribution
=0 for constant velocity distribution
=+1 for forced vortex velocity distribution

Experimental results describing early development of vortex devices may be found in several of the referenced publications. The 1964 Proceedings of the Fluid Amplifier Symposium at the Harry Diamond Laboratories contain experimental results obtained with vortex fluid amplification [Vortex Physics: Studies of High Temperature Superconductors (Studies of High Temperature Superconductors, Vol. 42) by A. V. Narlikar Publisher: Nova Science Publishers, Inc. (May 2002) ISBN: 159033342X; Implosion The Secret of Viktor Schauberger, Complied by Tom Brown, Translated from German by Jorge Resines; Viktor Schauberger and his discoveries Implosion vs. Explosion by Leopold Brandstatter; Implosion At First Hand from the 1977 July-Aug Journal of Borderland Research, by Riley Crabb; Viktor Schauberger and his work from the 1979 May-June Journal of Borderland Research by Albert Zock; R. Hilsch, The Use of the expansion of gases in a centrifugal field as a cooling process, review of scientific instruments XYI11, No. 2, February 1947, 108].

### OBJECTS AND ADVANTAGES

It is another object of the present invention to provide a system for converting zero point electromagnetic radiation energy to electrical energy.

It is another object of the present invention to provide a system for converting vacuum fluctuations to electrical and implosion propulsion.

It is another object of the present invention to provide a system for converting electromagnetic radiation energy to electrical energy, which may be used to provide such energy from any desired location on earth or in space.

It is another object of the present invention to provide a system for converting electromagnetic radiation energy to electrical energy having a desired waveform and voltage.

It is an object of the present invention to provide a robust system for converting electromagnetic radiation energy to electrical energy in order to enhance effective utilization of high energy densities of the electromagnetic radiation.

It is an object of the present invention to provide a system for converting electromagnetic radiation energy to electrical energy, which is simple in construction for cost effectiveness and reliability of operation.

It is an object of the present invention to provide a method of implosion propulsion.

Another object of the present invention is to provide a method of superconductive implosion propulsion based on quantum electro-dynamic vacuum fluctuations.

It is another object of the present invention to provide a system for converting electromagnetic radiation energy having a high frequency to electrical propulsion energy.

Yet a further object of the present invention is to provide a method of transportation driven and or otherwise propelled via a superconductive quantum electro-vortex implosion supporting at least one atom electrodynamic conversion to electrical and zero point energy.

Other objects, methods, advantages and features of the present invention will become clear from the following detailed description of the preferred embodiments of the invention when read in conjunction with the lab report a species embodiment and drawings as well as append claims.

An object of the present invention is to provide but not by way of limitations, an aircraft with a propulsion means for forming a rearward directed air stream as well as an improved embodiment comprising an implosive suction-head so as to propel the aircraft simultaneously. In other words the push and the pull energy contained within the elasticity of the air stream are combined whereby useful work is preformed.

Another object of the present invention is to enable sustained and accelerated flight duration, too solve these problems without excessive fuel consumption, over heating of the fuselage e.g., applying ceramic materials to the exterior hull section of the craft and eliminating excessive drag common to conventional aircraft design another object is to provide aircraft of the design embodied here with a means of cooling itself.

Yet a further object of the present invention is to provide an enhanced flexibility in aircraft design.

Still another object of the present invention is to provide an aircraft with either a low or a high flight speed capability while reducing frictional losses. Another object of the present invention is to provide variable flight characteristics in an aircraft.

An additional object of the present invention is to reverse parasitic drag into a beneficial energy source doing useful work otherwise caused by the incorrect application of geometrical structures having been applied by conventional designers whereby the present invention overcomes this defect through the proper selection of a functional shape.

Other objects, methods, advantages and features of the present invention will become clear from the following detailed description of the preferred embodiments of the invention when read in conjunction with the lab report a species embodiment and drawings and in conjunction with the implosion propulsion system as well as append claims.

### BRIEF DESCRIPTION OF THE DRAWINGS

FIG. 1 is a plane view of the receiving structures and antenna array of a first embodiment of the system of the present invention comprising a schematic view of the receiving conducting and converting components of an implosion propulsion unit thereof.

FIG. 2 is a plane view of the receiving structures depicting a regenerative feed back loop and circuit through a tandem pair of backward wave or reverse wave radio cavity frequency amplifiers of an antenna array of a second embodiment of the system of the present invention with a schematic view of the components thereof.

FIG. 3 is a perspective view of the receiving structures, antenna and waveguide of the second embodiment shown in FIG. 2 with a schematic view of the converter and propulsion unit thereof and also showing the incident primary and emitted secondary electromagnetic radiation.

FIG. 4 is a side view of the converter and propulsion unit mounted to a circuit board and a plurality of pairs of the receiving structures and a plurality of antennas of a third embodiment of the system of the present invention with a mechanical view of the conductors and converter and propulsion unit thereof and also showing the emitted secondary electromagnetic vortex radiation from the dielectric emitter plates.

FIG. 5 is a rear mechanical view of an optical atom coupled waveguide mounted on a sliding boom apparatus a loop accelerator antenna tank circuit consisting of a at least one set of spark gap electrode a tandem pair of reverse wave radio cavities and a pair of tandem dielectric plates also shown in FIG. 5 an optional horn feed and comprising components of the third embodiment of the system of the present invention.

FIG. 6 is a mechanical side view of the receiving structures and propulsion system of the present invention showing a tandem pair of dielectric plates with at least one surface of the dielectric plates shaped in a dome fashion.

FIG. 7 is a diagram of a resonant waveguide receiving structure of the system of the present invention showing an incident electromagnetic plane wave of light impinging on the optical receiving structures apertures and illustrating the directions of the electric and magnetic field vectors thereof showing the focal length of the light radiation and a secondary wave emission from the slotted line antenna structures mortised through the lower most wall of the resonating cavity structure also shown in FIG. 7 a detail of the optical receiving structures.

FIG. 8 is a diagram of an optical atom coupled waveguide and a ferrite bead choke coil and a shading coil utilized in the system of the present invention.

FIG. 9 is a exploded view of a optical atom coupled waveguide and showing the location of four capacitive tuning screws [CTS] and two inductive tuning screws (ITS).

FIG. 10 is a mechanical view of a ferrite bead choke coil and deflection yoke showing the location of four-safety spark gap adjusting screws.

FIG. 11 is a explode view of a lumped transmission line tank circuit comprising a set of dielectric component materials strategically stationed around the perimeter of the tank circuit loop accelerator antenna and spark gap transmitter.

FIG. 12 is an exploded view thereof a tank circuit comprising a set of optional inductive tuning screws strategically stationed around the perimeter of the tank circuit loop accelerometer antenna and spark gap transmitter.

FIG. 13 is a diagrammatic view of a spark gap electrode of a first embodiment used in the system of the present invention and attached with high voltage breaded wire thereof.

FIG. 14 is a cutaway view of an improvement to the tank circuit comprising a waveguide structure built into the loop accelerator tank circuit spark gap transmitter.

FIG. 15 is a cutaway view of an improvement to the tank circuit comprising a waveguide structure built into the loop accelerator tank circuit spark gap transmitter and showing a tank circuit loop antenna accelerator structure used in the present invention.

FIG. 16 is structural view of a coaxial magnetron backward wave or reverse wave radio cavity showing a space charge or spoke wheel rotating around the cathode of a coaxial magnetron tube.

FIG. 17 is an overhead view of an aircraft embodying the invention and particularly Illustrates the hyperbolic shaped horizontal vortex flow chambers the swirl vanes and eddy current diffusion cells FIG. 17A [22A] there on the surface of the wing and a means for controlling the vortex suction-heads illustrating an operational mode thereof.

FIG. 18 is an overhead view depicting the vortex formations [48] [48A] and [48B] of the aircraft shown in FIG. 17.

FIG. 19 is a rear elevation-al view of the aircraft shown in FIG. 17.

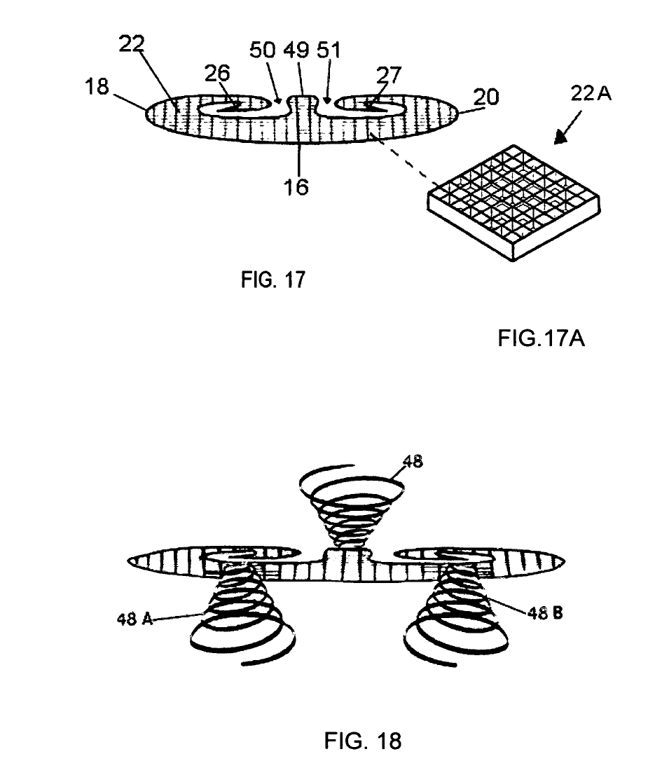

FIG. 18 is a front elevation-al view or the aircraft in FIG. 17.

FIG. 21 is a 45-degree angle view showing (S) or scallop pattern or pinched in shape (optional) of the fuselage and vortex chamber of an aircraft embodying the invention.

FIG. 22 is a side elevation-al view of one fuselage shape embodying the invention also showing a hyperbolic impression there in the nose cone of the aircraft a wave reversal unit, which is an impression, or void of a predetermined shape and depth embodying the invention.

FIG. 23 is a side elevation-al view of the preferred fuselage shape and configuration detailing a hyperbolic impression there in the nose cone of the aircraft a wave reversal unit, which is an impression, or void of a predetermined shape and depth embodying the invention.

FIGS. 24, 24A, 25, 25A and 26 depict species embodiments of the invention herein disclosed via lab reports.

### DETAILED DESCRIPTION OF THE PREFERRED EMBODIMENTS

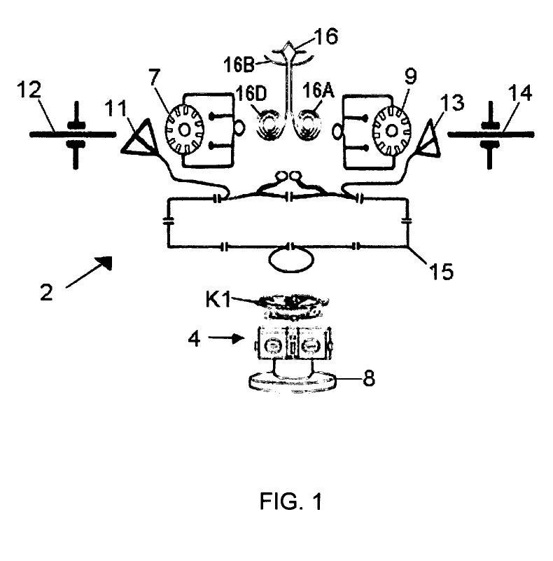

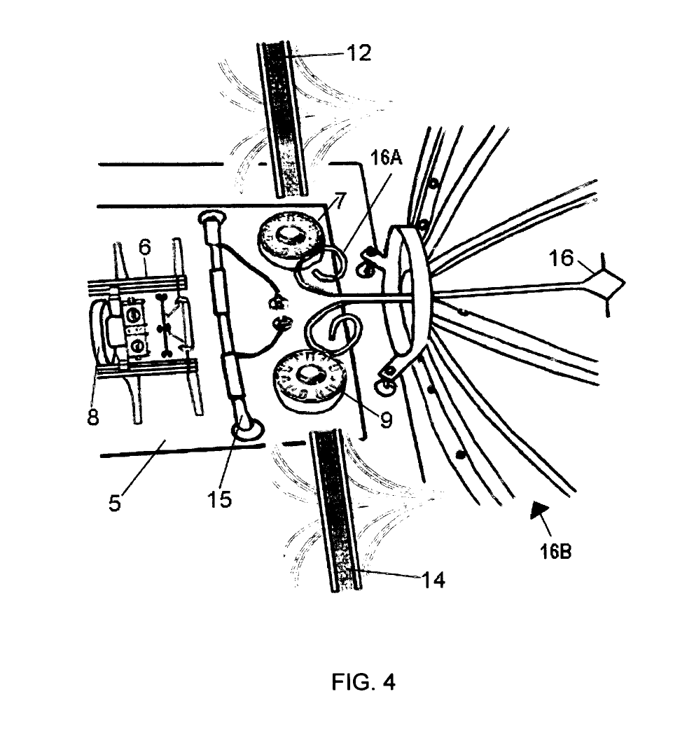

FIG. 1 shows a schematic view of a circuit [2] comprising a type of antenna array for converting environmental energy into electrical and implosion propulsion push and pull thrust an inductive resonant capacitive atom coupled optical cavity waveguide [4] attached to a sliding boom FIG. 4 [6] mounted on a suitable base FIG. 4 [5]. A feed horn [8] is supported at the central axis along a common boresight to permit precision mechanical alignment of said waveguide [4] and the feed horn [8] with the antenna array providing a means for receiving transmitting transceiving providing a sink and amplification but not by way of limitation vacuum fluctuations a polyphase counter clock rotating whistler wave the embodiment or generation of two or more phases electromagnetic (EM) radio frequency (RF) light gamma photon atom comprising at least one highly squeezed hour glass mode of operation including the converting of zero point electromagnetic radiation to electrical and implosion propulsion energy and also showing a set of antenna probes [11] and [13] a radiating surface for the purpose of obtaining a directional response shown proximal to dielectric plates [12] and [14] of said circuit composed thereof.

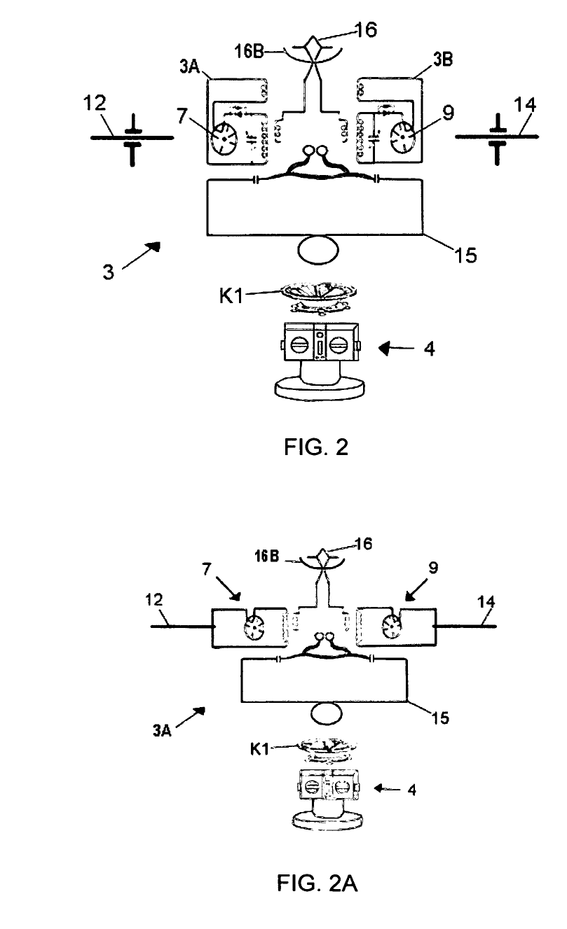

FIG. 2 depicts a schematic view thereof a second and optional wiring schematic of the receiving structures showing a super-regenerative feed back loop in this new system the factors of the circuits are so arranged that the amplifying oscillations set up by the tube do not depend so much on the feedback oscillations as on those which the oscillator tube itself sets up. This is caused by alternating the values of positive and negative resistance from moment to moment; that is, an alternating positive and a negative resistance are set up by the oscillations of the oscillator tube and circuit [3A] and [3B] a tandem pair of backward wave or reverse wave radio cavity frequency amplifiers [7] and [9] comprising an antenna array of a second embodiment of the system of the present invention with a schematic view of the components thereof circuit [3] embodied in FIG. 2 comprising a type of antenna array for converting environmental energy to electrical and implosion propulsion push and pull thrust FIG. 2 an embodiment of the system of the present invention.

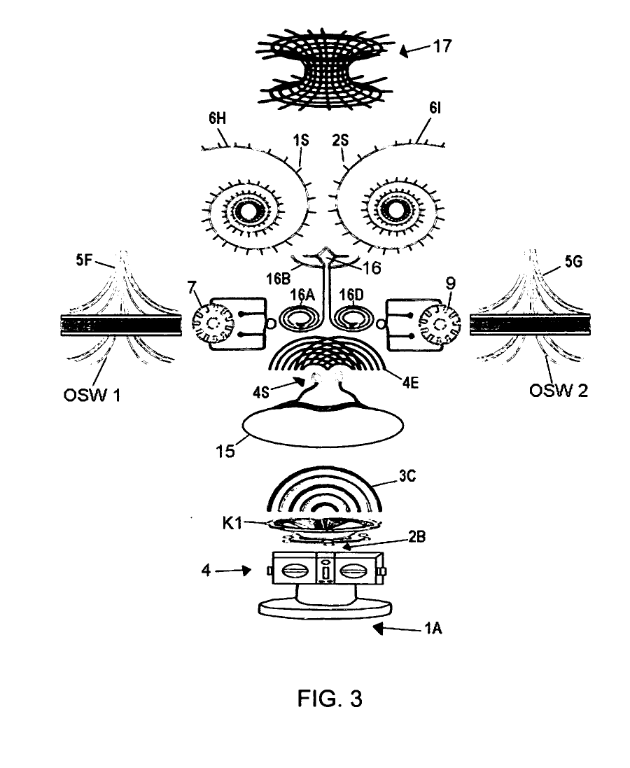

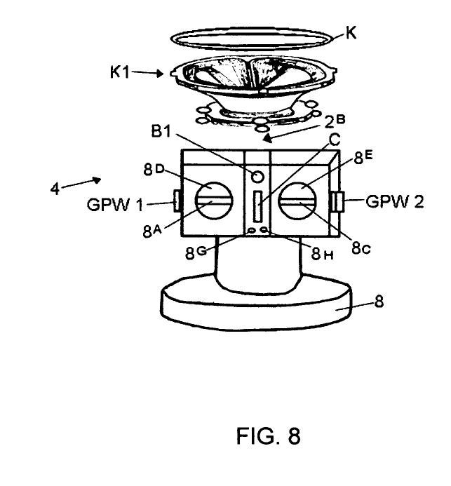

FIG. 3 is a schematic view thereof comprising an antenna array used in the present invention and also showing [1A] the incident primary a counter clock rotating whistler wave and an optical aperture waveguide [4] comprising an atom trap wherein a step in a series of chain reactions occur within an antenna array system an optical atom coupled waveguide composed of apertures from predetermined sizes shapes and or dielectric material holes for propagating but not by way of limitation electromagnetic waves or signals into or out of the waveguide comprising a radio cavity [4] thus coupling at least one atom into said resonant cavity [4] supporting at least one highly squeezed hour glass mode and coupling at least one atom therein (not shown) which may undergo a chain reaction thus be re-emitted as a secondary electromagnetic radiation a point source [2B] and inductively energizing or ringing in tune with a deflection yoke [K1] comprising a ferrite bead choke coil and FIG. 8 [K] a shading coil comprising a one way valve and set in close proximal to said resonate cavity [4] and safety gap system [K1] thereby converting said point source into a spherical wave front FIG. 3 [3C] thus energizing a tank circuit loop antenna accelerator structure [15] set in proximal along a common boresight and tuned to the same frequency to ring at resonance thus converting said spherical wavefront [3E] emitted by said deflection yoke [K1] and [15] re-emitted as [4E] an interfering wave pattern and electromagnetic implosive vortex suction heads [5F] and [5G] and [6H] and [61] a hyperbolic spiral wave form and beat frequency consisting of twin tandem reverse waves [6H] and [61] and a spike wave train [1S] and [2S] a twin out of phase spike wave train for the purpose of imitating the diamond lattice or scalar wave grid pattern diamond lattice each atom is connected to all other atom's covalent bonds in an orderly arrangement conceptualized as a diamond lattice or grid pattern in other words zero point energy the fabric of space and forming at least a portion of a square wave [1S] and [2S] comprising a secondary radiation composed of zero point energy [17] and in the proper phase when the waves [4E] from the spark gap transmitter [15] or loop accelerator encounter the fields of the delta antenna [16] comprising a delta triangular antenna section for matching a feeder line at its connection to a radiator thereby providing the condition for maximum power transfer and the waves of a common drift region (not shown) with [16A] an archimedes spiral coil and the waves [16B] a paraboloid dish antenna and the reverse waves of the radio cavities [6H] and [61] and the spike wave trains [1S] and [2S] the delta antenna [16] and the radio cavities [7] and [9] change from an oscillator to an emitter and begin emitting energy which can only occur when the fields around an antenna are given a reverse or backward traveling-wave field [6H] and [61] which provide the necessary stimulation thus causing secondary emissions to occur in the local region of space [17] showing a coherence of vacuum fluctuations a gravitational collapse pinch or highly squeezed region of the curved time matrix in three dimensional space of the near and far field [17] radiation patterns absorption and or emission require both the trapped fields [4E] at the delta antenna [16] with the trapped fields of coils [16A] and [16D] and vortex fields of [16B] composed of fields [17] as well as the hyperbolic spiral or backward wave fields emitted from the reverse wave cavities [6H] and [61] a hyperbolic spiral wave form which contain an ignition spike [1S] and [2S] comprising at least a portion of a square wave or arc emitted by the RLC loop antenna [15] accelerator and its spark gap [4S] discharge arc [4E] an interfering wave pattern or form the best demonstrations of RF electrical power available from the solar winds or electromagnetic spectrum is received power vs. RF frequency for experiments using ground based high power high frequency transmitters to perturb the ionospheric medium the highest peak on the scope indicates the MHz in RF pump energy from the antenna and transmitter system used in the present invention other peaks are due to interference signals the main signal of interest is the broad shoulder of energy produced by the dielectric materials of [12] and [14] which produce an electromagnetic vortex implosion [5F] and [5G] and also an over shoot wave form designated [OSW1] and [OSW2] the momentary increase of a quantity beyond its normal maximum value e.g., the spike seen on a square wave due to the over swing of a rising voltage and a nodule (not shown) in a planar pattern describing radiation as for antennas a small peak aligned in a direction other than that of a main lobe and or an antinode (not shown) a point of maximum amplitude in a standing wave; e.g., current node and the waves [5F] and [5G] which may be seen on the scope to the right or left of the peak I should point out that the bandwidth of the broad shoulder [5F] and [5G] is many times the bandwidth of the perturbing signal [2B] peak the concept of this invention is to provide a reflecting system that will allow this broad shoulder [5F] and [5G] of energy to cascade into a stable resonant flow between the environment and a reflector system. Once a resonance composed of a continuous echo is established the reflected energy will provide the perturbing radiation for stimulated emission and constructive interference entrainment with the electrical wave energy present within the environment as used in an embodiment of the system of the present invention

FIG. 4 is a mechanical view of said components as hereinbefore described above in FIGS. 1, 2, and 3 comprising an embodiment of the system of the present invention FIG. 4 and also showing the antenna array as used in the invention mounted on a two level base [5] or circuit board also showing a tandem electromagnetic vortex implosive suction head [5F] and [5G] emitted by the dielectric material of components [12] and [14] depicted in an embodiment of the system of the present invention thereof said system also [2] includes a first means for receiving but not by way of limitation at least one atom supporting at least one highly squeezed hourglass mode a second third forth fifth and sixth seventh eight ninth means for receiving incident primary and secondary electromagnetic radiation the means of implosion propulsion [12] and [14] are preferably a pair of dielectric plate structures which are preferably composed of a dielectric material.

Alternatively, the plates [12] and [14] may be cubical structures or any other suitable shape. The plates [12] and [14] may be mounted on a suitable foundation by any suitable mounting means (not shown), or plates [12] and [14] may be suspended from a suitable foundation by any suitable suspension means (not shown). I should point out that mechanical forces do become significant in resonant EM systems. Normal transformers and capacitors certainly do undergo significant mechanical forces the plates [12] and [14] are preferably composed of a dielectric material. The dielectric plates [12] and [14] scatter and concentrate electromagnetic waves in the form of hyperbolic spiral or vortex formations. At very sharply defined frequencies, the plates [12] and [14] will have resonance's wherein the internal energy densities can be several orders of magnitude larger than the energy density of the incident electromagnetic field driving the plates [12] and [14]. At resonance, the electromagnetic stresses, equivalent to pressures proportional to the energy density, can cause material deformation of the plates, [12] and [14] which produce a secondary electromagnetic field. The plates [12] and [14] are preferably positioned proximal to each other, as shown in FIGS. 1, 2, 3, 4, 5, and 6. Although the proximity of the plates to each other may adversely affect the resonances if placed in to close a proximity to one another, the very high “Q”s of the isolated dielectric resonances results in such adverse affect being relatively small. However, the proximity of the plates [12] and [14] allows the plates to interact electromechanically which increases the magnitude of the secondary radiation emitted therefrom. The electromagnetic radiation incident upon the plates [12] and [14] which drives the plates to resonance, is preferably zero point radiation [17] however, other types of electromagnetic radiation may also be used to drive the plates [12] and [14], if desired. The effect of a dielectric plate such as [12] or [14] on an incident electromagnetic radiation such as a plane wave thereof is shown in FIG. 3 The plane wave propagates in the z-axis direction (not shown) and is diffracted by the plates [12] and [14] resulting in scattering thereof. This scattering is commonly referred to as Mie scattering but generally comprises an electromagnetic vortex structure. The incident radiation wave has an electric vector component, which is linearly polarized in the x-axis direction, and a magnetic vector component, which is linearly polarized in the y-axis direction (not shown). An electromagnetic wave incident upon a structure produces a forced oscillation of free and bound charges in synch with the primary electromagnetic field of the incident electromagnetic wave the movements of the charges produce a secondary electromagnetic field both inside and outside the structure.

The secondary electromagnetic radiation comprising this secondary electromagnetic field is shown in FIG. 3 and designated by the numerals [2B], [3C], [4E], [5F], [5G], [6H], [61] and [17] an antenna which is shown simply as a loop antenna [15] but may also be any other suitable type of antenna is also shown in FIGS. 1, 2, 3, 4, 6, 11, 12, and 15 and designated by the numeral [15]. The mutual interactions of the plates [12] and [14] produces interference between the secondary electromagnetic radiation [4E], [7] and [6H] and [9] [61] thereby producing a beat frequency radiation [6A], [61] and [17] which is preferably at a much higher frequency than the primary radiation [1A] and [2B] and the beat frequency radiation of [4E] which is produced by resonant rise in the loop antenna accelerator tank circuit [15] is desired for conversion into electrical energy because it preferably is within the frequency range of RF radiation which may be converted into electrical energy by generally conventional systems that is a spark gap arc. Thus, the radiation [3C] received by the antenna [15] is fed via an electrical conductor [15] to a means for converting the beat frequency radiation [4E] to electrical energy. This means for converting is designated by the numeral [4S] and preferably includes a tuned or tunable circuit.

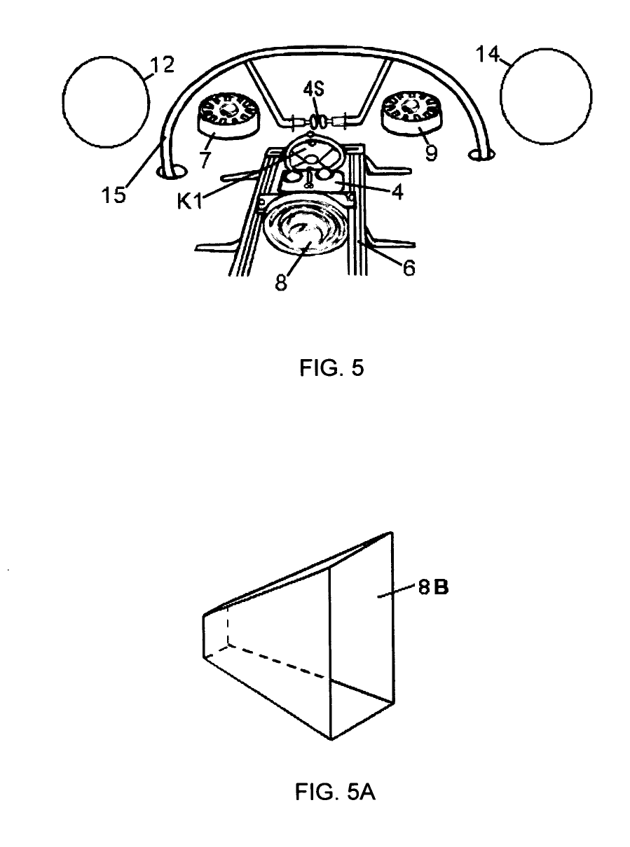

FIG. 5 is a rear mechanical view of an optical atom coupled waveguide [4] supporting at least one highly squeezed hourglass mode and supporting the coupling of at least one atom into said waveguide suitable for at least one or more chain reaction to occur said waveguide [4] is shown mounted on a sliding boom apparatus [6] suited to mechanically adjust said waveguide [4] also shown in FIG. 5 is a deflection yoke [K1] comprising a ferrite bead choke coil and safety gap system whose purpose is to receive a point source [2B] and to reemit same as a spherical wave front thereby charging a loop accelerator antenna [15] a tank circuit comprising at least one set of spark gap electrode [4S] and thereby energizing a tandem pair of reverse wave radio cavities [7] and [9] and a delta coil and dish antenna (not shown) and a pair of tandem dielectric plates [12] and [14] this forming a implosion propulsion system also shown in FIG. 5A an optional horn feed tapered waveguide [8B] but not by way of limitation said horn feed [8] and [8B] my be of any type that is suited to guiding electromagnetic waves into the optical waveguide cavity and well know to those skilled in the art and comprising components of a preferred embodiment of the system of the present invention.

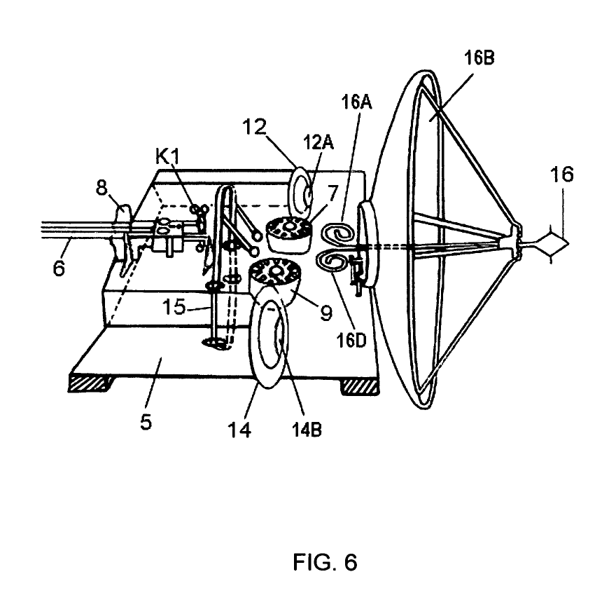

FIG. 6 is a mechanical side view of the receiving structures and propulsion system of the present invention shown mounted on a suitable nonmetallic circuit board [5] and showing an optical waveguide [4] a sliding boom [6] a horn feed [8] a deflection yoke [K1] and spark gap electrodes [4S] a loop antenna or induction coil tank circuit [15] a tandem pair of backward wave radio cavities [7] and [9] a tandem pair of dielectric plates [12] and [14] with at least one surface of the dielectric plate [12A] and [14B] shaped in a dome or tiara fashion a paraboloid dish antenna [16B] and a delta antenna [16] and archimedes spiral coil [16A] and [16D] forming an edge tone oscillator between the drift region thereof [7] and [9] of the radio cavities said archimedes spiral coil [16A] and [16D] which is forming an edge tone oscillator circuit between the drift region of said backward wave radio cavities [7] and [9] may also be a strap line coil (not shown) mounted on the anode structures inside of said coaxial magnetron cavities [7] and [9] and well know to those versed in the art of radio cavity structures therein.

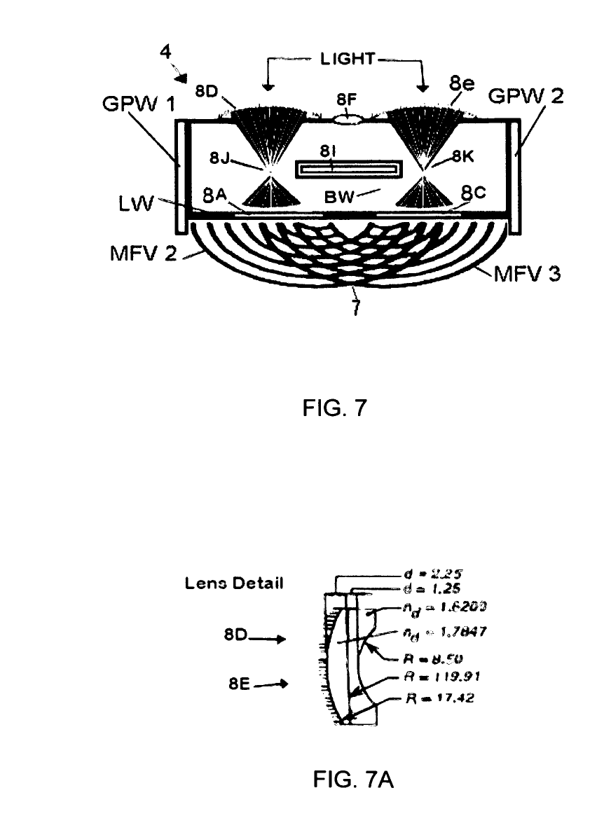

FIG. 7 is a diagram and cutaway end view of the electric field vector wall (not shown) of the resonant cavity showing a resonant waveguide receiving structure [4] a wing or grounding structures designated [GPW1] and [GPW2] in an antenna or other radiator, a (usually flat) member attached to, and sticking out from, another member such as a grounding plane of the system of the present invention also showing an incident electromagnetic plane wave impinging on the optical receiving structures [8D] and [8E] and aperture [8F] and apertures [8G] and [8H] (not shown) also showing aperture [8I] a rectangular aperture but not by way of limitation said aperture my be any suitably shaped or sized aperture excised through the back wall of said waveguide back wall designated [BW] and illustrating the directions of the electric and magnetic field vectors (not shown) therein and showing the focal length of the light radiation [8J] and [8K] and a secondary interfering wave emission [1] passing through and emitted by said slotted line antenna structures [8A] and [8C] mortised through the lower most wall of the resonating cavity structure designated [LW] with electromagnetic rays being passed through a double slit comprising a lens aperture or coaxial lens optical structure herein described above and below and passing through a screen but not by way of limitation lens apertures [8D] and [8E] to produce coherent light or electromagnetic radiation. This light is then projected onto another screen that has twin (or double) slits [8A] and [8C], which again diffracts the incident illumination [1] as it passes through. The results of interference between the diffracted light beams can be visualized as light intensity distributions the coherent wavefront of light impacting on the twin slits is divided into two new wavefronts and dispersed along the magnetic field vectors designated [MFV2] and [MFV3] that are perfectly in step with each other. Light waves from each of the slits [8A] and [8C] must travel an equal distance and reach said slot line [8A] and [8C] slit points still in step or with the same phase displacement.

Because the two waves reaching said slot line slit points possess the necessary requirements for constructive or destructive interference, they add together to produce an interference fringe on the screen [LW] through said slotted line antenna [8A] and [8C] slit structures of [4] the waveguide.

FIG. 7A depicts a view of an optical lens detail as used in the present invention comprising a multielement lens structure thus forming an integral design step in an optical cavity which allows considerable flexibility in realizing a cavity having a large g factor and a large active volume simultaneously that supports multiple lambda scale waist hour glass modes over a large active volume the cavity is comprised of two coaxial lens reflectors each consisting but not by way of limitation of a double lens whose external convex surface may have a reflective dielectric coating or a low reflectivity dielectric coating (R=0.85) which may be applied to the external convex surface ensuring a sufficiently broad cavity resonance at full working aperture of the cavity resonance off axis on axis source points couple to modes resembling those shown in FIG. 7 [8J] and [8K] diffraction limited self-imaging is achieved over an active region of a predetermined diameter of the effective focal length of the working aperture diameter of the lens reflector [8D] and [8E] the cavity free spectral range the end to end optical path length at lambda=a predetermined nm where c is the speed of light. A well known cavity QED effect is the modification of atomic spontaneous emission The largeness of my cavity bandwidth relative to g leads me to expect atoms within the active volume of said cavity and to display exponential spontaneous atomic decay with a rate that is predetermined by size and shape of the focal length of the lens apertures and cavity structure as well as the size and shape of the propagation of said apertures in said cavity are advantageously effected by component techniques that are familiar to the person skilled in the art, for example, methods similar to that described in the article.

FIG. 8 is a mechanical diagram view of an optical atom coupled waveguide comprising an atom trap as used in the present invention and also showing a ferrite bead choke coil a deflection yoke and safety gaps and a shading coil used as a one way valve and similar in function to a solenoid and is utilized in the system of the present invention herein set forth above as below and designated alphanumerically.

A horn feed [8] a waveguide flange [A1] a flat lip like fitting at the end of a waveguide pipe which serves to fasten wave guide sections together or to attach a wave guide component equipped with an identical flange to the end of a wave guide (not shown) [A2] a waveguide resonator a waveguide section employed as a cavity resonator waveguide and composed of apertures FIG. 8 [B1] [8G] [8H] composed of dielectric materials lens apertures [E1] and [E2] and [B1] [8G] [8H] are holes for propagation and the transmission of electromagnetic energy through and into or out of said waveguide by successive reflections between the waveguide and the inner walls a choke flange [C] at the end of a wave guide a flange in which a groove forms a choke joint and connecting two wave guide sections together and permitting efficient energy transfer without requiring electrical contact with the inside wall of the waveguide a wing or grounding plane.

FIGS. 7 and 8 [GPW1] and [GPW2] in an antenna or other radiator a usually flat member attached to and sticking out from another member such as a grounding plane a waveguide lens [E1] and [E2] a microwave or optical lens comprising a waveguide section which provides the required phase shifts a waveguide slotted line antenna FIG. 7 and FIG. 8 comprising a section of waveguide composing a slotted line antenna [8A] and [8C] forming a dipole trap thereby effectively trapping and or couple an atom or multiples of atoms within said resonant cavity a shadow area [J] the vicinity in which signal attenuation or the absence of a signal results from the shadow effect a shadow attenuation the attenuation of electromagnetic energy caused by an obstacle generally measured in decibels the simulation of energy caused by the curvature of said obstacle shadow effect the obstruction of radio waves by objects in their path shadow medium a shadow whose width is proportional to current a shading coil a single short circuited turn copper ring [K] encircling the tip of the core of an AC carrying coil such as the field pole of a motor [K1] a choke coil a current induced in the coil causes a momentary flux shift that approximates a rotating field which self starts a simple single phase induction capacitance motor whose materials comprise a choke coil to restrict or curtail passage of a particular current or frequency by means of a discrete component such as a choke coil or a deflection yoke a ferrite bead choke coil comprising a magnetic storage device or material in the form of a bead slipped over current caring leads to choke out RF a deflection yoke the ferromagnetic ring or cylinder which holds the pole pieces of a dynamo type generator and acts as part of the magnetic circuit a system of coils employed for magnetic deflection of the electron beam source FIG. 3 [2B].

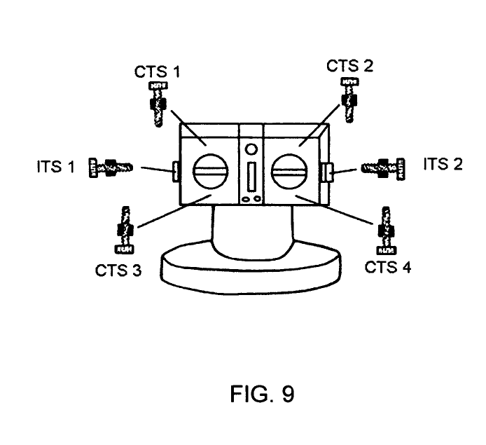

FIG. 9 is a exploded view of a optical atom coupled waveguide as used in the present invention and showing the location of four capacitive tuning screws designated [CTS 1], [CTS 2], [CTS 3], [CTS 4] and two inductive tuning screws designated [ITS 1] and [ITS 2].

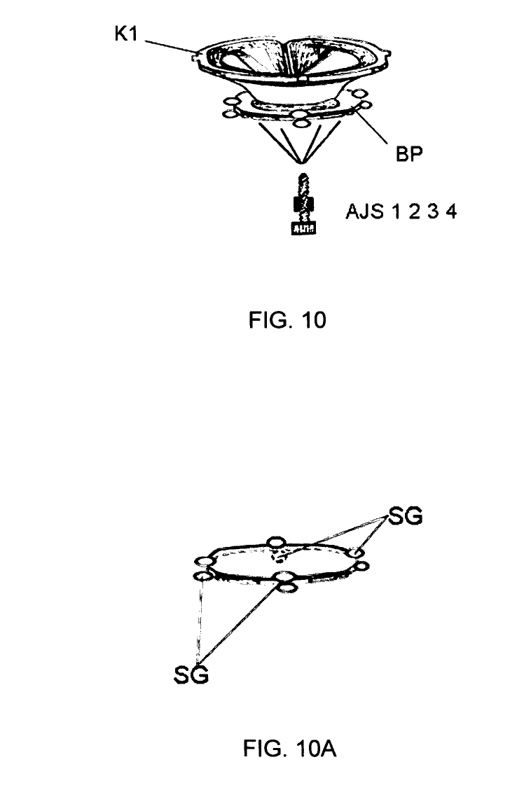

FIG. 10 is a mechanical view of a ferrite bead deflection yoke and coil K1 as used in the present invention and showing a safety spark gap electrode system designated spark gap [SG] mounted there on an adjustable non metallic backing plate designated [BP] backing plate of which three sets of four such safety gap electrodes are shown and also showing the non metallic adjustment screws designated [AJS] means to set the spark gag and backing plate settings by adjustment screws as used in the present invention.

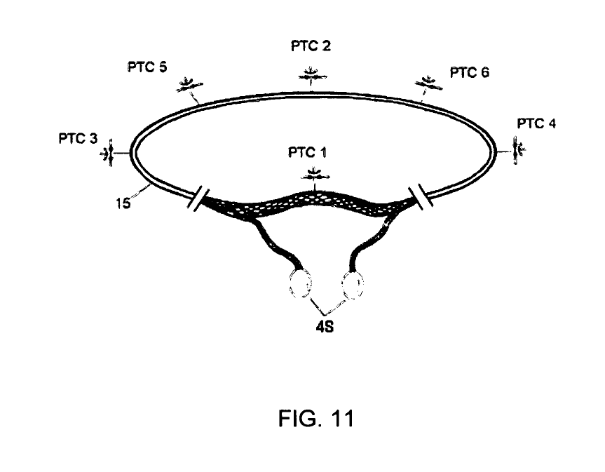

FIG. 11 is a explode view of a loop antenna accelerator tank circuit 15 and spark gap electrodes 4s as used in the present invention comprising a set of dielectric component materials [PTC1], [PTC2], [PTC3], [PTC4], [PTC5], and [PTC6] or pass through capacitors a lumped element pertaining to a property that is concentrated at or around a single point rather than being distributed through a circuit.

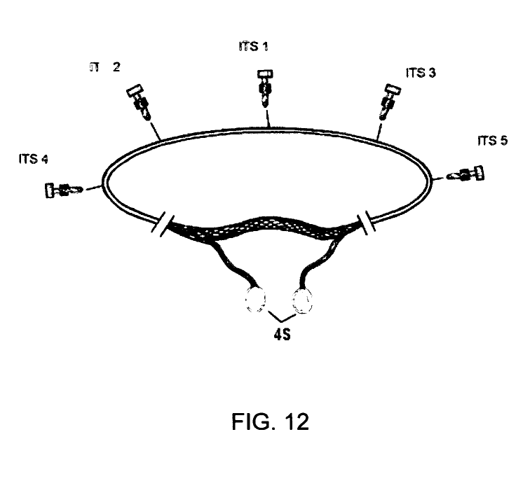

FIG. 12 is a explode view of a tank circuit [15] as used in the present invention comprising a set of optional inductive tuning screws lumped inductance [ITS1], [ITS2], [ITS3], [ITS4], and [ITS5] strategically stationed around the perimeter of said tank circuit loop accelerator [15] antenna and [4S] a spark gap transmitter also showing a pass through capacitor composed of dielectric material.

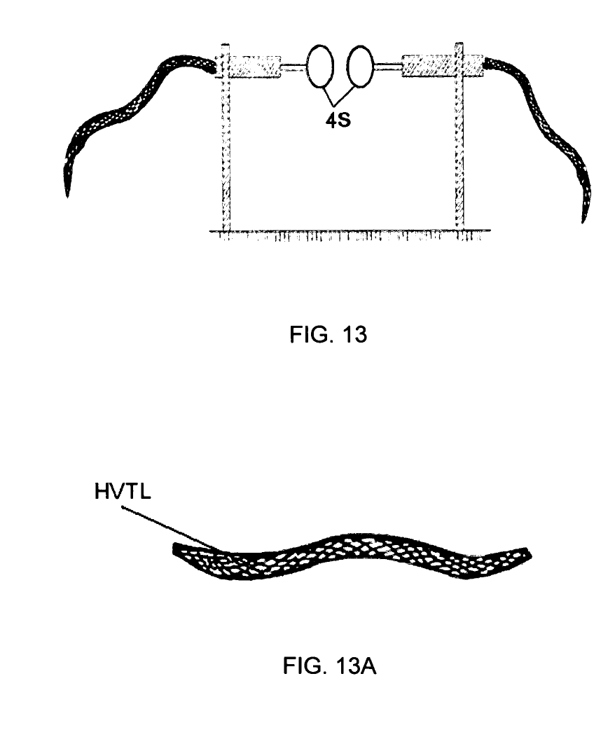

FIG. 13 is an adjustable sphere gap electrode composed of two metal balls separated by a small air gap a high voltage applied to the electrodes causes a spark or in the case of an ac voltage a train of sparks to jump across the gap a spark gap oscillator comprising spark gap [4S] and a tuned LC tank circuit [15] (not shown) or damped wave oscillator FIG. 13A is a detail showing a braided high voltage transmission line designated [HVTL] electrically connecting said tank circuit [15] (not shown) to said spark gap electrodes [4S] as used in the present invention.

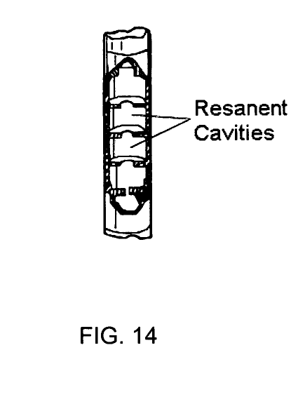

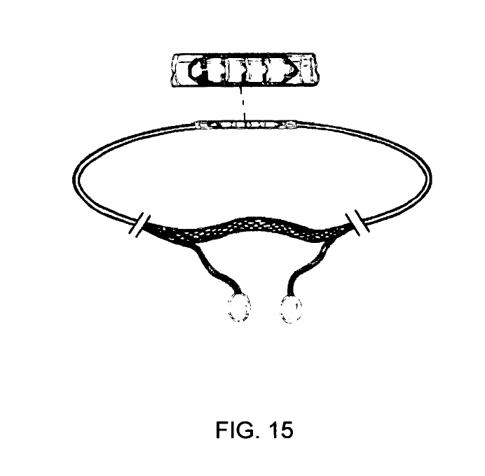

FIG. 14 is a cut away view of an improvement to the loop antenna accelerator tank circuit FIG. 15 comprising a waveguide structure FIG. 14 built into the loop accelerator FIG. 15 of the tank circuit spark gap transmitter.

FIG. 15 is a cutaway view of said improvement depicted in FIG. 14 to the tank circuit loop accelerator comprising a waveguide structure built into the loop accelerator tank circuit spark gap transmitter and showing said tank circuit loop antenna accelerator structure used in the present invention Inside the accelerator structure the electromagnetic waves from FIG. 3 [3C] set up currents in the copper that cause oscillating electric fields pointing along the accelerator as well as oscillating magnetic fields in a circle around the interior of the accelerator pipe such that the electrons arrive in each cell or cavity of the accelerator just at the right time to get maximum push and pull from the electric field in the cavity said electrons must arrive when the field is pointing the opposite way to be pushed or pulled in the same direction the size of the cavities in the accelerator are matched to the wavelength of the electromagnetic waves of [3C] FIG. 3 so that the electric and magnetic field patterns repeat every three cavities along the accelerator in principle electron bunches follow one another three cavities apart the spacing between said bunches are always kept in multiples of three cavities for the same sign particles.

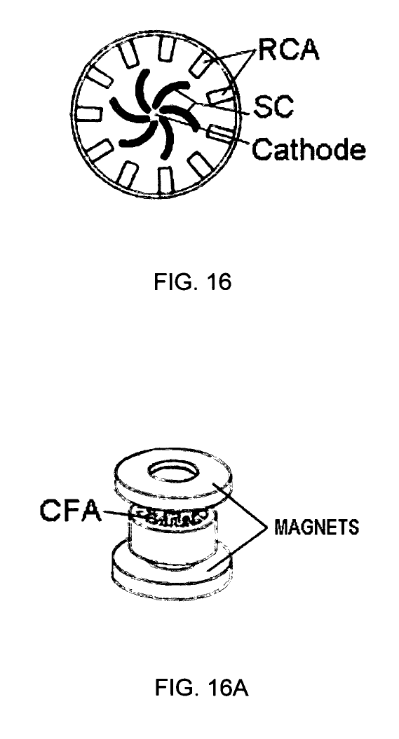

FIG. 16 is a structural view of a reverse wave radio cavity [RCA] showing a space charge or spoke wheel [SC] rotating around the [Cathode] of a coaxial magnetron tube FIG. 16A is a magnetron tube detail comprising a set of permanent magnets designated [MAGNETS] a cavity comprising a backward wave crossed field microwave frequency amplifier designated [CFA] composed of an anode cavity FIG. 16 [RCA] and pins (not shown) forming the resonator circuits the cavities and excited in opposite phase by a strap line (not shown) comprising the delta antenna coil [16] and [16A] shown in FIGS. 1, 3, 4, and 6 composed of either or both strap line or edge tone oscillator the nucleus of the high voltage system is the magnetron tube which is a diode type electron tube used to produce the required beat frequency energy it is classed as a diode because it has no grid as does an ordinary electron tube a magnetic field imposed on the space between the anode plate and the cathode serves as the grid while the external configurations of different magnetrons will vary the basic internal structures are the same these include the anode the filament or cathode the antenna and the magnets the theory of magnetron operation is based on the motion of electrons under the combined influence of electric and magnetic fields for the tube to operate electrons must flow from the cathode to the anode under these fundamental laws that govern their trajectory as electrons flowing through a conductor cause a magnetic field to build up around that conductor so an electron moving through space tends to build up a magnetic field around itself on one side of the electron's path this self induced magnetic field adds to the permanent magnetic field surrounding it on the opposite side of its path thus having the opposite effect subtracting from the permanent magnetic field and therefore the electron's trajectory bends in that direction resulting in a circular motion travel by the electrons accelerating to the anode.

The whirling cloud of electrons influenced by the high voltage and the strong magnetic field form a rotating pattern that resembles spokes in a spinning wheel FIG. 16 [SC] the interaction of this rotating space charge wheel with the configuration of the surface of the anode produces an alternating current flow in the resonant cavities of the anode as a spoke of electrons approaches an anode vane the segment between two cavities it induces a positive charge in that segment as the electrons pass the positive charge diminishes in the first segment while another positive charge is being induced in the next segment current is induced because the physical structure of the anode forms the equivalent of a series of high Q resonant inductive capacitive LC circuits and is otherwise well know to persons in the art as a coaxial magnetron tube.

This section below describes the system used in the present invention as a superconductive implosion propulsion energy source used in the present invention as a spacecraft or aircraft.

The system of the present invention may become a super conductive implosion propulsion system through a multifold process means for receiving for borrowing and converting said atom coupled electromagnetic energy extracted from within an environment means to amplify said environmental energy and return said energy back into said environment without loss of said energy therein beginning with an inductive application of electromagnetic energy induced through the dielectric materials of [12] and [14] and comprising a form of propulsion known as implosion which is in the form of an electromagnetic vortex or suction head [5F] and [5G] having both a pull and a push thereby mechanically comprising an implosive pull and an explosive push whereby a broad shoulder of energy may cause the formation of an overshoot wave such as square wave or over swing wave of energy [OSW1] and [OSW2] to occur in the vicinity of the dielectric materials of [12] and [14] located on the thrust or explosive push side of and [14] and located at [OSW1] and [OSW2] and also exhibited by said broad shoulder of energy is a node and or antinode and or may be composed of nodules of iron oxides particles or any suitable composition including a ceramic composition comprising a predetermined compound which may protrude above the surface of the magnetic field of [12] and [14] it is therefore an object of my invention to provide an apparatus for converting the energy of an electrical potential FIG. 3 [15], [4S] and [4E] directly into a mechanical implosive force [17] [5F] and [5G] suitable for causing relative motion between a structure and the surrounding medium another object of this invention to provide a novel apparatus for converting an electrical potential directly to usable kinetic energy to provide a novel apparatus for converting electrostatic energy directly into kinetic energy to provide a vehicle motivated by electrostatic vortex energy FIGS. 17-22.

Without the use of moving parts to provide a self propelled vehicle without moving parts to provide an apparatus for producing relative motion between a structure and the surrounding medium said apparatus includes a pair of electrodes FIG. 3 [4S] of appropriate form held in fixed spaced relation to each other and immersed in a dielectric medium and oppositely charged another feature of my invention is to provide a source of high electrical potential connected between the body of the craft and the environment and the propulsion system via harmonic or inductive means said electromagnetic implosive vortex energy is reproduced throughout the system of the present invention by the function of the QED implosion system and predetermined sets throughout the electromagnetic functionality of said QED implosion system comprising additionally a triune vortex implosion which is set into motion as a direct result of the geometric shape of the vacuum cohesion craft designated (VCV) FIGS. 17, 18, 19, 20, 21, and 22 a ram induction impeller a first vortex implosion is encountered by said QED implosion unit in the form of a whistler or scalar wave (not shown) which is impinging on the surface of the horn feed waveguide FIGS. 1, 2, 3, 4, 5, 5A, 6, 8, and 9 comprising a polyphase counter clock rotating wave (not shown) a second and third vortex implosion occurring within said optical cavity FIG. 7 [8J] and [8K] in the form of light passing through the tandem set of lens apertures and polarizing or phase shifting therein said resonant cavity a forth and fifth electromagnetic vortex implosion; comprising a tandem pair of reverse waves FIG. 3 [6H] and [61] composed of a spike wave train [1S] and [2S] are formed by the function of the reverse wave radio cavities [7] and [9] which combine to form a sixth electromagnetic vortex implosion [6H] and [6I] and beat frequency a seventh and eight vortex implosion occurring there at the dielectric materials of [12] and [14] a ninth vortex implosion occurs there at the delta antenna [16] and paraboloid dish [16B] both inside the craft and outside the craft there in free space and [17] showing a highly squeezed or pinched curved space-time matrix comprising a gravitational collapse a triune atmospheric vortex implosion may occur by the forward motion and geometric shape of the VCV craft FIG. 18 [48], [48A] and [48B] an atmospheric vortex formation is caused by the reverse wave paraboloid impression designated [49] there in the nose cone section of FIGS. 18, 20, and 23 of said craft and other vortex formations occur there in.

FIG. 18 at the wing tip vortex generators [26] and [27] said vortex formation which is occurring there in the atmosphere may be generated by the geometric shape of the craft as well as the vortex formations generated by the QED implosion propulsion unit within the electromagnetic spectrum and/or environment play a major roll in the generation thereof a harmonic cooling which is prerequisite for the occurrence of superconductive phenomenon displayed by certain compositions of conductors that demonstrate no resistance to the flow of an electric current superconductors also exhibit strong diamagnetism that is they are repelled by magnetic fields superconductivity is manifested only below a certain critical temperature Tc and a critical magnetic field Hc, which may vary with the material used ultra low temperature operation places a severe constraint on the overall efficiency of a superconducting machine cryogenic liquids and systems needed for cooling is a serious economic and technological disadvantage there is a great difference between switching on a machine as needed and having to supply continuous refrigeration or having to wait for refrigeration systems to reach operating temperatures however this is not the case with the VCV craft and QED implosion propulsion system due to the rotation of both electromagnetic and atmospheric vortex action setting into motion a cooling effect which is manifest and leveraged from the direct action of the atmospheric harmonics as well as the rotary vortex of the atmosphere and the action of the electromagnetic vortex rotary which set up a thermal acoustic effect and was first observed centuries ago by glass blowers, they noticed that the tube attached to a hot expended glass bowl would tend to cool and begin singing the first demonstration of the reverse process with sound used to pump heat for cooling was in 1982 when physics professor Stephen Garrett and his colleagues at the naval postgraduate school in Monterey Calif. figured out a away to cycle a standing sound wave into an efficient system for refrigeration.

Thermoacoustic refrigeration systems have been tested on the space shuttle and used for surveillance satellites whose equipment require very low temperatures as do superconductors and the function of the QED propulsion unit by doping the local drift region of the environment outside the craft and the ceramic material with ionization contained within a plasma vortex which is diffused around the perimeter of the VCV craft by the diffusion pattern FIG. 17 [22A] a quadratic diffusion cell resembling a waffle pattern.

Thermoacoustic alternative vortex refrigeration is powered by standing sound waves caused by a temperature gradient which may set up a sound wave causing an interaction between the atmosphere and horizontal vortex chamber to harmonically sing or whistle this new refrigeration technique is decidedly low-tech however practical for producing ambient temperature superconductive devices a predetermined frequency comprising a standing wave note at just the right frequency to set up a standing wave of sound causing environmental cooling via vortex possessing a predetermined atmospheric pressure the sound waves cause the atmospheric gas to go through cycles of compression and expansion which is a key factor to acoustic cooling because gas heats up a bit when compressed and cools as it expands when a compression phase of the sound wave comes along the gas molecules of the atmosphere collide within said vortex and the VCV hull structure from which it radiates away then the gas expands and cools further than it would otherwise and some of its heat has been drawn off the process a progressive cooling which can be exploited for refrigeration the result is a refrigerant system that uses no ozone depleting CFCs and has only one moving part the environment it is the direct manipulation of said environment that conveys the craft along with its relative motion the only issue keeping the acoustic refrigeration system from producing an ambient temperature super conductor is a lack of interdisciplinary talent the people who do cryogenics do not know acoustics maybe this is the reason why there has been so little advancement in the art of ambient temperature super connectivity and when current is applied to the ceramic composition of the VCV aircraft standing sound waves get compressed and heat up nearby atmospheric molecules these atmospheric molecules collide and transfer some of their heat and cool down a bit after expanding the atmospheric molecules end up with less heat energy and are cooler than when they began the cycle researchers have already built a number of working acoustic coolers some capable of producing temperatures of around minus 100 degrees Fahrenheit and have even been used aboard the space shuttle because they have fewer moving parts than conventional cooling systems acoustic coolers may well be suited to applications on satellites and space vehicles and even for ambient temperature super conductors where efficient maintenance free cooling is crucial.

In the embodiment of FIGS. 17 and 17A [22A] located on all surfaces are two-dimensional waffle-type patterns dispersed on the surface of the wing, that is a quadratic-residue diffuser, a two-dimensional cell that diffuses acoustical energy and (preferably eddies currents) in both the horizontal and vertical planes for all angles of incidence thus forming a vacuum state many times higher in degree then the surrounding environment [The Master Hand-Book Of Acoustics 3-RD Edition “Everest” Diffusion In Three Dimensions pp. 256-262].

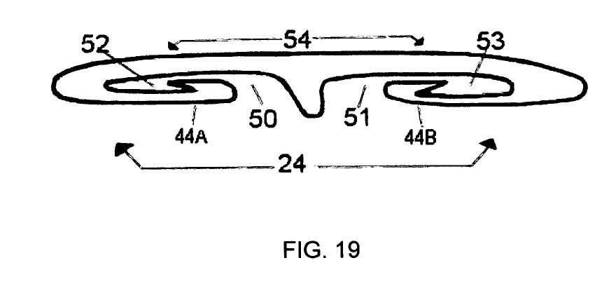

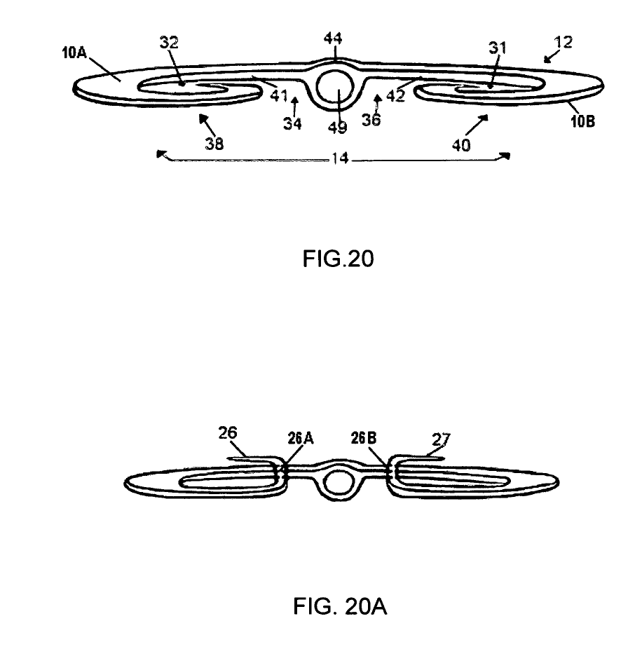

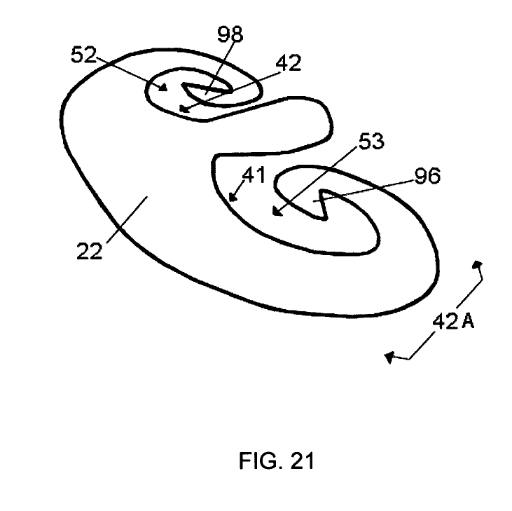

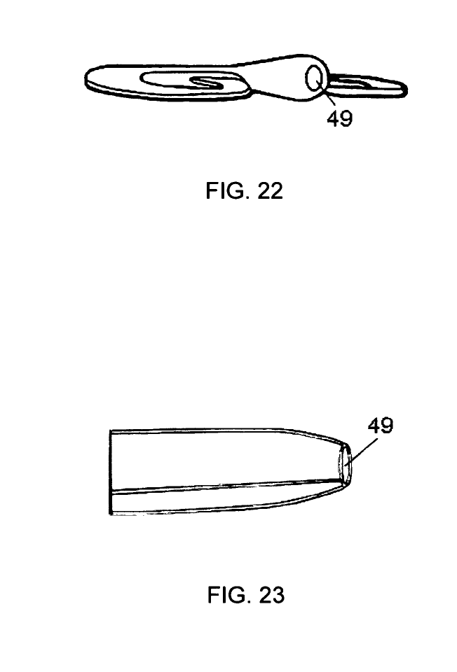

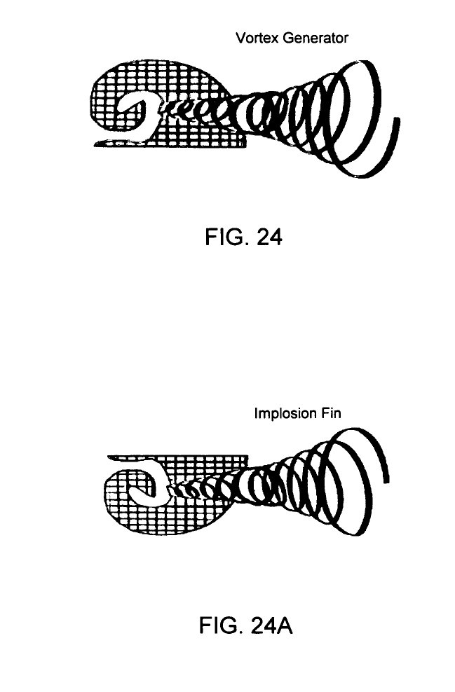

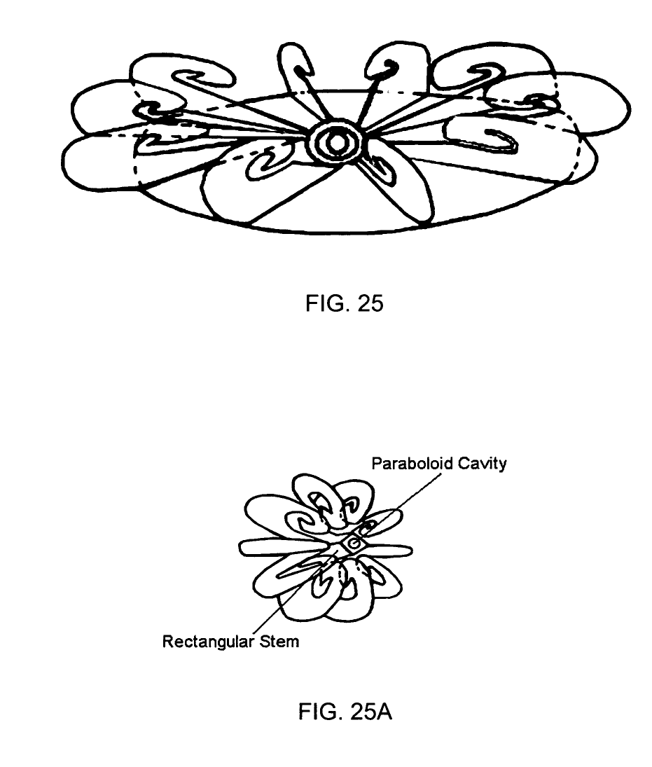

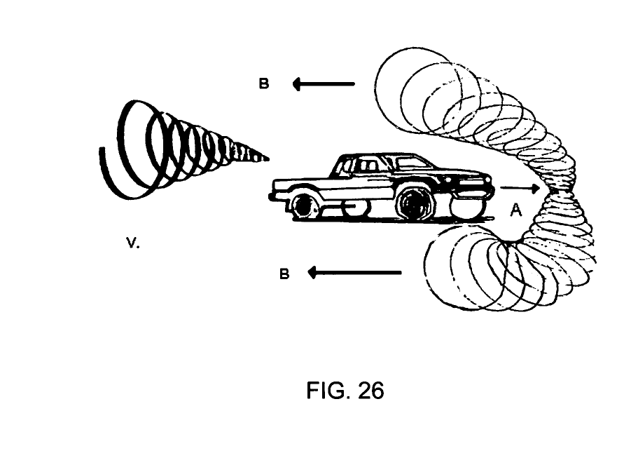

FIG. 17 is a diagrammatic representation of one specific embodiment of a component 1 in accordance with the invention generally indicates an internal wing there disposed within a horizontal vortex flow chamber aircraft comprising a flying-wing fuselage FIG. 20 [12] having a forward end FIG. 17 a rear end [16], a first side [18], a second side [20], an upper surface FIG. 21 and a lower surface FIG. 19 [24], the connotations top and bottom being used to generally indicate the uppermost and lowermost surface of the aircraft FIG. 20 [10A] and [10B] when the aircraft is in substantially level flight, or in a stationary mode. A control surface [26] and [27] are provided at the aircraft's vortex-swirl-vane FIG. 17 and left and right hand control surfaces [28] and [30] are disposed at the front of the craft on opposite sides [28] and [30] and are movable simultaneously, but in opposite directions, to produce a rolling movement about the longitudinal axis of the aircraft [1] and may therefore be rendered optional and may be removed from the craft when controlled or steered electronically (not shown) verses mechanically.

FIG. 18 is an overhead view depicting the vortex formations of the aircraft shown in FIGS. 17-22 whereby atmospheric vortex action sets into motion a cooling effect which is leveraged from the direct action of the atmospheric harmonics produced by said rotary vortex said vortex rotary which sets up a thermal acoustic effect or thermoacoustic alternative vortex refrigeration powered by standing sound waves caused by a temperature gradient formed there in the convergence zone of FIGS. 17 and 18 there forming vortex suction-heads to occur which may set up a sound wave causing an interaction between the atmosphere and vortex chamber to harmonically sing or whistle this new refrigeration technique is decidedly low-tech however practical for producing ambient temperature superconductive devices a predetermined frequency comprising a standing wave note at just the right frequency to set up a standing wave of sound causing environmental cooling via vortex possessing a predetermined atmospheric pressure the sound waves cause the atmospheric gas to go through cycles of compression and expansion which is a key factor to acoustic cooling because gas heats up a bit when compressed and cools as it expands when a compression phase of the sound wave comes along the gas molecules of the atmosphere collide within said vortex and a vacuum cohesive vehicle VCV hull structure from which it radiates away then the gas expands and cools further than it would otherwise and some of its heat has been drawn off the process a progressive cooling which can be exploited for refrigeration the result is a refrigerant system that uses no ozone depleting CFCs and has only one moving part the environment it is the direct manipulation of said environment that conveys the craft along with its relative motion the only issue keeping the acoustic refrigeration system from producing an ambient temperature super conductor is a lack of interdisciplinary talent.

The people who apply cryogenics do not apply acoustics maybe this is the reason why there has been so little advancement in the art of ambient temperature super connectivity and when current is applied to the ceramic composition of said VCV aircraft standing sound waves get compressed and heat up nearby atmospheric molecules these atmospheric molecules collide and transfer some of their heat and cool down a bit after expanding the atmospheric molecules end up with less heat energy and are cooler than when they began the cycle.

Researchers have already built a number of working acoustic coolers some capable of producing temperatures of around minus 100 degrees Fahrenheit and have even been used aboard the space shuttle because they have fewer moving parts than conventional cooling systems acoustic coolers may well be suited to applications on satellites and space vehicles and even for ambient temperature super conductors where efficient maintenance free cooling is crucial.

An engine or suitable quantum electro-dynamic power plant as shown in FIGS. 4 and 6 mounted in the forward end FIG. 20 of the aircraft [1] in any suitable manner as is well known and the power plant may also be any type which produces a rearward air stream and/or vortex flow or suction-head so as to provide thrust for the aircraft [1]. Of course, suitable conventional landing gear (not shown) may be provided for the aircraft which my therefore be rendered optional and may be removed from the craft when propelled via quantum electro dynamic implosion propulsion FIGS. 4 and 6 verses mechanically and/or conventionally and/or radio or electronic steering control devices (not shown) are provided for guidance and optionally the actuation of the control surfaces in the usual or well-known manner may also be omitted thereby opting for electronic steering (not shown).

Horizontal hyperbolic vortex chambers FIG. 21 [52] and [53] are provided in the airfoil or fuselage FIG. 20 [12] and [44] of craft [10] with the forward end of the input elements [34] and [36] provided with openings [34A] and [36B] disposed on opposite sides of the fuselage [44] and on opposite sides of the power plant or engine shown in FIGS. 4 and 6 of VCV FIGS. 17, 18, 19, 20, 21 and 22 craft [10]. In addition, the vortex chambers FIG. 21 [52] and [53] are provided with openings FIG. 20 [31], [32], [38], and [40] disposed on the opposite sides of the fuselage [44] and disposed on opposite sides of the flying wing [12] and on opposite sides of the engine shown in FIGS. 4 and 6. The upper most section [42] FIG. 21 of the chambers [52] and [53] depicted a substantially ellipsoidal egg-shaped configuration and the ports or openings [34], [36], [38] and [40] are separated by a centrally disposed fuselage means FIG. 20 [44] and swirl-vane system FIG. 17 [26] and [27].

The upper surface of the swirl-vane [26] and [27] provides a floor or bottom FIG. 20 [10B] for a passageway [38] and [40] that communicates between the hyperbolic chambers FIG. 21 [52] and [53] and the openings FIG. 20 [34A] and [36B] and that of [34], [36], [38], and [40] and the upper contour FIG. 21 [42] of the main wing.

The lower surface FIG. 19 of the vortex swirl-vane means [44A] and [44B] provides a convergence zone or surface at the hyperbolic chambers [52] and [53] at the input elements [38] and [40] and the appropriate configuration of the hyperbolic chamber [52] and [53] and the substantially hyperbolic egg-shaped configuration of the surface FIGS. 17, 19, and 20 [34], [34A], [36], [36B], [41], [42], [50], and [51] converge to provide a reduced area or throat [50] and [51] shown in FIGS. 17, 19, and 20 an input to said hyperbolic chamber [52] and [53] disposed aft of the openings [34], [34A][36], [36B], [50], and [51].

As the air stream moves through the ports or openings [34A] and [36B] the velocity thereof is increased by the configuration of the forward section of the hyperbolic chamber and vortex swirl-vane, this increased velocity at the exit of the throat [41] and [42] creates a suction at the converging passageway [31], [32], [34A], [36B], [38], [40], [52], and [53] for drawing in ambient air through the ports [34], [36], [38], and [40]. The combined air-streams then move rearward through the hyperbolic horizontal vortex flow chambers [52] and [53] there flowing across the upper surface of the main wing turning vane whereby the rearward jet-stream of moving air is further accelerated and turned down for discharge at the aft-end [16] of the wing thereof.

At least two movable flap means [28] and [30] (not shown) are hinged or secured in any well-known manner at the front open end [14] of the vortex chambers that are selectively movable by the operator of the aircraft FIG. 17 [28] and [30] and secured substantially in the center of the hyperbolic chamber in spaced relation with respect to each other and movable simultaneously and in the same direction to provide a vertical force along the leading edge of the aircraft FIG. 17 thus changing the attitude of the craft, as is well known and may therefore be omitted when electronically steered.

Referring now more particularly to FIG. 19 a rear elevation-al view of the under portions of the hyperbolic chambers [52] and [53] view thereof. The cross sectional configuration of the hyperbolic chambers [52] and [53] at the leading edge opening FIG. 20 [34], [36], [38], and [40] are substantially elliptical shown at [52] and [53] in FIGS. 19 and 21. The cross sectional configuration of the vortex chambers [52] and [53] becomes substantially elliptical as the vortex chamber progresses in the direction of the throat or input elements FIG. 20 [34], [36]. FIG. 19 [50], and [51] the elliptical configuration being shown FIG. 19 [52] and [53].

The cross sectional configuration of the throat or input elements [50] and [51] as shown in FIG. 19 may be configured substantially pinched-in rectangular hyperbolic or other suitable shapes an example may be curved in. This graduation of the configuration of the vortex chambers [52] and [53] controls the movement of the air stream between the openings FIG. 20 [34], [36], [41], and [42] and the throat FIG. 19 [50] and [51] whereby the speed of the air stream is substantially squeezed as it enters the throat as herein set forth.

The aircraft shown in FIGS. 17-22 are provided with a pair of oppositely disposed inwardly extending relatively small wings swirl-vanes [26] and [27] likewise the aircraft shown in FIGS. 17-22 are provided with external wings there disposed within horizontal vortex chambers. The lifting force in the craft is attained entirely by the main wing section in conjunction with the internal hyperbolic vortex amplification chamber and swirl-vane system FIG. 17 as hereinbefore described. The novel aircraft design lends itself as desired to an efficient glider or single or multiple engine design or a quantum electro dynamic implosion propulsion system as shown there in FIGS. 4 and 6.

The aircraft as shown herein, may be provided with at least two engines (not shown) or powered by a quantum electro dynamic implosion propulsion system as desired and shown in FIGS. 4 and 6 In addition, the novel aircraft design may be utilized in the construction of large transport or cargo aircraft or spacecraft with equal efficiency and economy of operation and construction.

The lift for the aircraft [10] is generated by the action of air moving over the main wing section whereby the air is accelerated through the hyperbolic vortex chambers [52] and [53]. The swirl-vane directs the airflow from the underside and forward input elements [38] and [40] to the rearward outlet [16] for discharge at the rear of the craft. The movement of the air stream moving over the contoured section of the floor or upper most surface [12] creates a pressure and velocity change in the air stream. The configuration of the vortex chamber is such that a lower pressure is created on the roof or undermost surface [12] of the main wing than is created on the floor or lowermost surface [24] of the wing. The net difference in the pressure change results in an upward force or lift. The shape of the vortex swirl-vane and/or the configuration of the inner periphery of the hyperbolic chamber and the amount of air that moves through said vortex amplification chamber and across the main wing structure control this force.

The configuration of the vortex swirl is altered by the mechanical control mechanism [28] and [30] which may be deleted when electronically steered (not shown) which not only varies the configuration or contour of the vortex swirl FIG. 18 [48A] and [48B] of the hyperbolic chambers [52] and [53] and upper surface [10A] of the chamber. As the airspeed is increased through the vortex chambers [52] and [53], and FIGS. 20 [22], [23], [49] a wave reversal chamber composed of a predetermined size and depth there disposed within the nose cone section of the craft said wave reversal unit actually turns the air-stream encountered by the craft away from the aircraft FIGS. 20, 22 and 23 forming a vortex or suction-head FIG. 18 [48], [48A], [48B] requiring less fuel to be expended as opposed to conventional craft that are tapered to a point which actually turn the air stream back antagonistically toward the craft whereby more conventional fuels are required to generate the desired flight parameters Conversely, as the airspeed is decreased, more fuel is required to maintain the usual aircraft's required vertical force or lift.

Of course the chamber size must be sufficiently great so as to permit the airflow through the contoured section of the vortex chamber without undue restriction of the movement of the air stream with the contoured section configured with the greatest or highest curvature for the contoured section of wing FIG. 21 [22]. Similarly, the size of the vortex chamber cannot be so large that the air stream is allowed to pass through the chambers [38] and [40] without being properly influenced by the contoured sections.

The actual particulars of the vortex-chamber its shape and size are dependent on the considerations controlling the detailed design of the aircraft for its anticipated mission requirements. The operation of the vortex chamber and the contained contoured section FIG. 21 [42] provide the characteristics necessary to fulfill the fundamental requirements for producing a lifting and/or propulsion force for the aircraft.

It will be readily apparent from the drawings that the plane of the input elements [34] and [36] of the vortex chambers [52] and [53] are angularity disposed with respect to the direction of the incoming airflow. The vortex chamber inputs [34] and [36] are sensitive to this angular alignment, as is well known in the nature of input elements in general. The larger the angular alignment the larger the airflow properties as the air stream enters the vortex chambers [52] and [53] and begins its movement through said chamber. There are some small practical limits to this consideration, and this is the reason for the incorporation of the usual pitch-attitude control that is much like that of a conventional aircraft's major control device.

The flaps provide the pitch control [28] and [30] (not shown) and a swept-up or a turned up tail section (not shown) usual to flying wings aft section [16]. When these flaps are operated in conjunction with each other simultaneously and in the same direction, a vertical force is produced along the trailing edge of the aircraft [16], thus changing the attitude of the craft. Of course this attitude change may be computer controlled or otherwise monitored by the pilot in order to adjust the alignment of the aircraft with the airflow.

Similarly, the pilot of the craft may maintain the directional control of the aircraft [10]. The directional alignment of the control surfaces [28] and [30] their directional alignment play an important role in the efficiency of the aircraft's stability and is fundamental to the maneuvering of the craft to a desired position or place. The horizontal jet-stream turned-up vane or tail section usual to flying wing aircraft (not shown) and the swirl-vane flaps [28] and [30] provide the necessary force to produce a rolling movement or level flight plan of the craft when flow by usual methods.

The rolling control of the craft is accomplished by the utilization of the flaps [28] and [30] (not shown). It is preferable that the flaps [28] and [30] (not shown) be arranged in co-operating left and right hand pairs, with one of each pair being disposed on each vortex swirl-vane. The flaps or control surfaces of the right hand pair may be moved together, and the flaps of the left hand pair may be similarly moved together but in opposite directions with respect to the movement of the right hand pair.

This split movement feature produces a rolling movement about the longitudinal axis of the aircraft and modulation of the operation of these control surfaces will enable the pilot to bank, roll, and otherwise maneuver the craft in much the manner as a conventional aircraft. Of course, as herein-before set forth, all of the control vanes and/or surfaces are operably connected in any suitable or well-known manner including radio control or electronically steered (not shown) for actuation by the pilot of the craft optionally all moving parts including flaps of any suitable type that are capable of steering said craft may be deleted or otherwise removed the equation when electronic steering is chosen (not shown).

The function of the vortex chamber [52] and [53] are based on the amount of air moving through the input element section [34], [34A], [36] [36B], [38] and [40] and swirled by the vortex swirl-vane [26] and [27] thereof to produce the desired vertical and linear force for the particular flight conditions of the aircraft [10]. The movement of the air-stream through the vortex chamber [52] and [53] is the result of energy that is supplied to the air stream by the aircraft and its systems. This energy is supplied by moving the craft through the air ramming or by pumping the air through the vortex chambers by some mechanical means. When the forward movement or velocity of the aircraft i.e. produces the entire airflow ram induced, the performance of the craft will not be dependent solely upon the power available to move the craft through the air. When the air stream is ram induced FIG. 21 through the vortex chambers [52] and [53], the performance of the vortex chamber and the craft are greatly enhanced.

Similarly, pumping of the air may be accomplished in any suitable manner, such as by utilization of an impeller fan, ionization, quantum electro dynamic implosion propulsion system or the like, as shown in FIGS. 4 and 6 which may be disposed at either the intake or outlet end of the vortex chamber. Under these conditions, more energy is usually available when the fan is utilized to produce both a suction force and too produce a pressure simultaneously. In other words, it may be expedient to place the Impeller fan at the outlet of the vortex chamber rather then the inlet thereof.

Pumping of the air FIG. 21 through the vortex chambers [52] and [53] may also be accomplished by pumping a percentage of the air stream through the input elements [50] and [51] at higher pressure and entraining the remaining air by viscous action, which is the principle of a jet pump. In the aircraft this is accomplished by diverting the air from the power plant or engine (not shown) of the craft into the input elements FIG. 20 [34] and [36] of the vortex chambers FIG. 21 [52] and [53] and discharge the air stream through the outputs thereof.

The air stream entering the input elements [34] and [36] moves to the throat or pinched pipe area FIGS. 17 and 3 [50] and [51] where the velocity of the air stream is increased and as the air stream exits through the pinched pipe or throat area [50] and [51], ambient air is pulled into the vortex chambers [52] and [53] through the input elements [38], [40], [50], and [51].

The generation of a lifting force by flowing air through an internal passage, FIG. 21 such as the vortex chambers [52] and [53], are dependent upon the shaping of the passageway itself, and the utilization of the contoured chambered portion [42A] is much like the upper surface of an airfoil configuration wherein a velocity change is created in the air as it passes over the main wing having passed through the vortex chamber. Since the shaping is primarily contained within the wing [10] of the vortex chambers [52] and [53], the largest velocity change occurs along the floor [12] and a lesser velocity change occurs along the under surface of the wing FIG. 19 [24] of the vortex chambers [52] and 53.

Proportional to the changes in velocity along the length of the vortex chambers FIG. 21 [52] and [53], the pressure acting on the floor [10B] is increased and the roof [10A] is reduced.

The pressure along the floor or upper surface of the wing [10A] is reduced more than the pressure along the roof [10B], thereby creating a pressure differential between the two surfaces. This pressure differential acts on the surface area of the contoured portion of the wing FIG. 21, [22] and [42A] to create a vertical force in much the same manner, as does an external wing structure.

The relationship between the pressure change in the air stream passing through the passageway or vortex chambers [52] and [53] and the shape of the inner periphery [41] and [42] of said vortex generators [26] and [27] are directly related to the co-ordinate dimensions of the contour size and shape, and this relationship is well defined and computable by conventional and well known methods. In the flying of an aircraft, lift has always been conventionally controllable by changes in the angle of attack, coordinated with an airspeed or change in airspeed of the craft.

In the novel invention a ram implosion wing aircraft [10] the requirements are to produce a change in lift by changing the coordinate dimensions of the vortex generators or swirl-vanes [26] and [27] and their control surfaces [28] and [30] for the given airspeed or change in airspeed, and this is accomplished by the actuation of the control device (not shown). The effects of pitch attitude are the same in the aircraft [10] as in conventional external wing aircraft and are utilized in the production of lift in the craft [10] except when the optional control means (not shown) is by electronic steering said mechanical actuation my be removed from the craft.

The mathematics and physics surrounding the calculations of the velocity ratios at each horizontal vortex chamber are represented by the Navier-Stokes equations for an incompressible fluid. Because the domain of flow is unbounded and vortex rings are known to diffuse and translate, the equations are expressed in translating, expanding spherical co-ordinate airflow. As an example of the effects of the contour of the floor [42A] on the velocity of the air stream passing over it, a comparison between a low curvature surfaces may be made.

As herein-before set forth the configuration or contour of the inner periphery of the vortex swirl chamber [52] and [53] is controlled by contour means thereof [52] and [53], and as the airspeed is increased through the vortex chamber, less expenditure of conventional fuels are necessary to generate the desired vertical force or lift. Conversely, as the airspeed is decreased, the greater the fuel expenditures required to maintain the required vertical force or lift for the aircraft due primarily to the decrees in ram inductive forces.

From the foregoing it will be apparent that the present invention provides a novel aircraft utilizing an internal wing concept there disposed within an externally mounted wing wherein an internal hyperbolic vortex swirl chamber extends through the fuselage of the aircraft and is provided with inlet means at the forward end and passing through the upper and lower section of the wing thereof and outlet means at the top surface and aft end of the wing thereof. The air stream passing through the vortex chamber creates an upward force or lift for the craft and control vanes are provided for achieving the usual or desired operational characteristics for the craft generally similar to more conventional external wing aircraft and optionally said control vanes may be disposed of in favor of electronic steering (not shown).

The novel aircraft concept lends itself to application for single engine, multi-engine craft (not shown) or super-conductive quantum electrodynamic implosion systems as shown in FIGS. 4 and 6 high-speed operational craft, large transport and or cargo craft, spacecraft, or substantially any other desired in-flight operational requirements.

### SUMMARY OF THE INVENTION

It is a principle object of the present invention to provide a system for converting cavity quantum fluctuations to achieve large atom-light coupling strengths strong atom-light coupling means for coupling a single atom, which may significantly influence the quantum statistical properties of the electromagnetic field inside the optical atom, coupled waveguide resonator. It also means that a single photon inside the cavity can now strongly affect the behavior of one or several atoms to convert electromagnetic radiation energy to electrical and/or to electromagnetic and/or to vortex propulsion energy comprising a superconductive implosion propulsion method of transport.

Optical excitation provides an important means of controlling the internal state of quantum systems. This is particularly true in transient settings where pulsed excitation allows for detailed quantum state preparation. A vital gauge or measure of the effect of an optical pulse on a resonant two-level system is given by the quantity known as area or the time-integrated product of signed optical field and atomic transition matrix element. Control over the area of an optical pulse implies control over its effect on an atomic specimen. Ordinary sources of optical pulses do not provide for direct control over area—secondary quantities such as power, temporal waveform and temporal duration must be monitored and manipulated.

It has been demonstrated that a rapidly decaying cavity can be employed to dramatically accelerate the rate of Dicke super radiance in optically thin samples. Super radiance involves a natural coupling between optical fields emitted and the internal state of atoms involved. That atom-cavity property of transforming input optical pulses of arbitrary area to output pulses having quantized or discrete areas. Optical sources are important to areas such as quantum state preparation, quantum computing and coherent control.

Cavity atoms experience significant squeezing under the influence of strong driving fields. These squeezing effects are intrinsically connected to the polarization of dressed state populations by tuning the cavity appropriately close to the atomic transition frequency we may induce a non-vanishing inversion of the dressed-state's setting the standard for optimal conditions for atomic squeezing.

In the case of an isolated two-level atom, the most important damping mechanism is a spontaneous radiative decay.

This mechanism is associated with the coupling of the atom to the zero point electromagnetic fields empty-cavity transmission resonances are found to split in the presence of the atoms and under these conditions the cavities temporal responses are found to be oscillatory. These effects may be viewed as a manifestation of a vacuum-field Rabi splitting or as a simple consequence of the linear absorption and dispersion of the intercavity atoms.

Interesting aspects of atomic behavior in the presence of strong driving fields appear when the driven atom resides not in free space, but in a region (such as an optical cavity) that displays a frequency-dependent photon-mode density. Under such conditions, it is found the strong driving fields can modify the spontaneous decay properties of an atom thereby give rise to interesting new features in the spectrum of strong-field fluorescence.

It is also found the high-level dressed-state polarization can be maintained in a sample of resonantly/nonresonantly driven atoms by appropriate tuning of an enclosing cavity. Furthermore, for appropriate RF frequencies and cavity tunings it is found that the atomic state becomes highly squeezed. In the course of analyzing these effects, a set of modified Bloch equations is derived that explicitly accounts for the finite response time associated with a frequency-dependent photon-mode density.

Essentially, the system of the present invention utilizes a set of RF cavities disposed in tandem with one another an antenna array structure optical atom-coupled waveguide for receiving incident electromagnetic radiation which may be propagating through a vacuum or any other medium in which the receiving structures may be suitably located. The system of the present invention is specifically designed to convert the energy of zero point electromagnetic radiation; however, it may also be used to convert the energy of other types of electromagnetic radiation including but not by way of limitation atom gamma photon light RF acoustic vacuum.

A tank circuit comprising a spark gap transmitter is an integral part of the conversion process, which converts the received energy to useful electrical energy. The converter preferably includes a tuning circuit or comparable device so that it can effectively receive the resonant radiation oscillation emissions produced in conjunction with the optical atom-coupled waveguide and ferrite bead choke coil a deflection yoke and shading coil resonator a one-way valve and that of incident environmental energies.

The receiving structures of the implosion-propulsion system are preferably composed of dielectric material in order to diffract and scatter to couple to external bodies the incident electromagnetic radiation capable of coupling to external bodies. In addition, the receiving structures are of a volumetric size selected to enable the structures to resonate at a high frequency of the incident electromagnetic radiation based on the parameters of frequency of the incident radiation and propagation characteristics of the medium and of the receiving structures.

Since zero point radiation has the characteristic that its energy density increases as its frequency increases, greater amounts of electromagnetic energy are available at higher frequencies. Consequently, the sizes of the structures are preferably miniaturized in order to produce greater amounts of energy from a system located within a space or area of a given size. In this regard, the smaller the size of the receiving structures, the greater the amount of energy that can be produced by the system of the present invention.

At resonance, electro magnetically induced material deformations of the implosion propulsion receiving structures produce secondary fields of electromagnetic energy therefrom which may have evanescent energy densities several times that of the incident radiation capable of coupling with external bodies. The structures are of different sizes and shapes so that the secondary fields arising therefrom are of different while adding constructively in frequency. The difference in volumetric size and the proximal zones are very small so that interference between the emitted radiation fields, and the receiving structures at the two different frequencies produces a beat frequency radiation, which has a much higher frequency than the incident radiation the beat frequency radiation preferably is at a frequency that it may be relatively easily converted to a useable reverse wave and electrical-implosion-propulsion energy of a higher energy density having a desired voltage and waveform.

Note: Incident zero point radiation has its desirable high energy densities at frequencies which are so high that conventional systems for converting the radiation to electrical energy either cannot effectively or efficiently convert the radiation energy or simply cannot be used to convert the radiation energy for reasons beyond usual methods.

The system of the present invention also includes an antenna, which receives the beat frequency reverse wave radiation. The antenna may be a conventional metallic antenna such as a loop or dipole type of antenna or a RF cavity structure that partially encloses the receiving structures or of any type antenna that meets or exceeds the impedance matching criteria of systems requirements. The antenna feeds the radiation energy to an electrical conductor in the case of a conventional dipole or comparable type of antenna or to a waveguide in the case of an RF cavity structure.

The conductor or waveguide feeds the electrical current in the case of the electrical conductor or the electromagnetic radiation (in the case of the waveguide) to the environment and from the environment back into said antenna and amplification beat-frequency-recycling-system via english a backward wave structure a reverse wave stimulated emission circumspect to an antenna or antenna arrays unique ability to resonate transmit and too receive simultaneously.

The invention further consists in a method of manufacturing a component of this kind comprising the following steps:

Usual aircraft construction methods and materials applicable to the aerospace industry including superconductive ceramic compositions of materials and usual electronic methods and materials including antenna array designs applicable to the electronic and aerospace industries.

Electronically speaking the construction of my invention is straightforward my invention employs an all inductive method of energizing the system thereby preventing losses due to restrictions and or heat with only one exception said reverse wave or co-axial magnetron tubes may become heated the rest of the system operates in a cold fashion due in part to the lack of direct connections in other words I am utilizing antenna propagation as a transceiver or reception and transmission of EM, [light], RF resonant energy to accomplish the interconnectivity of the circuit. Said system consist of several different antenna design collectively comprising an antenna array orientation thereby manifesting into an all induction circuit self energized via resonant rise oscillations and atoms scavenged from the electromagnetic spectrum existing there in free space.

A low pressure sink of electromagnetic vortex energy is created at the parabolic dish by reflection of energy and delta antenna which may be inductively connected or strap lined into a set of twin reverse wave cavities said energy sink is blocked open in one direction by the shading coil mounted to the end of the yoke deflection coil. This implies that there is a specific frequency at which the unit operates that is to say the atomic transition frequency thus its resonant frequency.

There is a special frequency targeted in the design known as the atomic transition frequency. A complex cavity QED waveguide and network determines this resonant frequency.

To get the cavity QED Inverter to resonate atom, gamma, photon, light, ZPE or any other type of electromagnetic energy has to be coupled into it at the appropriate rate and frequency. A good analogy is that of a bell. To get the bell to ring, you need to tap it with a hammer. If you tap too hard, you can crack the bell; and if you tap and hold the hammer on the bell too long you do not get a clean pure tone out of the bell.

The potential which appears at the high voltage terminal spark gap transmitter/loop antenna is developed through a process known as resonant rise which can greatly exceed the voltage that would otherwise be expected from conventional iron core transformers, using a simple calculation based upon the ratio of primary to secondary turns, that is to say ratio of transformation.

While in operation the system is continuously recharged by the flowing of ambient energy fields to the lower density sink byway of a cavity QED single-atom coupled antenna and ferrite bead choke coil and shading coil comprising (a one way valve) thus allowing for an uninterrupted flow of current through the circuit.

Spacing which forms a drift region between components minimizes inductive coupling between the transmission line coil and the Optical Atom-Coupled Cavity, preventing for the most part a portion of the energy that is continuously flowing into the resonator from passing backward through the system and becoming lost. Spacing also allows for focal length adjustments consisting of a sliding boom apparatus.

One aspect that might be looked at is the freedom of vibration, ordinary ferromagnetic transformer must have tight coupling, or a high amount of mutual inductance between primary and secondary, thus the use of a material to convey magnetic flux between the cores to effect this transformative voltage rise made by turns ratio. Then resonance dose not come into the picture, except for reactive power corrections.

Circumspect to the phenomenon of sympathetic resonance where one tuning fork in vibration will also set another identical tuning fork into vibration. The fact that both are free to vibrate allows the effect to occur but if we clamped the bases together this might interfere with the sympathetic resonance as we are damping out those free vibrations by tighter coupling between the parts whereby giving them that direct line coupling we may in fact stop or kill all sympathetic oscillations.

Conversely, this facet is shown to a much lesser degree with air core resonance when the primary is in the closest coupling, naturally we get the best efficiency, but the load of the secondary hinders the vibration of the primary (voltage wise) thus moving the primary farther away from the secondary will allow the primary to express more amperage given the amount of voltage inputted to the primary because now the q factor of the primary has gone up, allowing its internal voltage rise to go higher than in the case for a tighter coupling.

There is an obvious tradeoff here, by moving the primary farther out, the secondary receives less of the primaries flux change, but at the same time doing this has allowed the primary to input more energy as amperage input per impressed voltage and larger voltage gain on the primary itself all of these phenomena of resonance are frequency dependent, in which your secondary coil is only going to work when you engage the primary to ring at the same frequency of ring that the secondary rings too.

Over coupling might actually dampen the ring factor out of the equation, thus each part must have some freedom of vibration hence the separation of components. Since the ferrite bead choke coil transformer relies only on the material to convey the flux change, it is not dependent on some frequency that it will naturally ring too we can try to make it ring if desired, but it will be a highly damped ringing, going no where near the levels of voltage rise that would be predicted by its registered inductance set to a particular resonant frequency in fact doing this might saturate the core, meaning that no further amount of amp-turns of magnetic field are being created for the increased primary input. The advantage of air cores is that they do not saturate, and the lack of ferromagnetic inertia allows them to vibrate as fast as can be feasibly constructed by design.

Another aspect to all of this is that the higher the frequency the more lossy the ferromagnetic components become the primary industrial use of higher frequencies seems to be that of induction heating, where essentially those high loss factors become evident for ferromagnetic materials at high frequencies.

The natural RF energy and the natural ionic energy both in space as well as in the ionosphere pump the resonance and no manmade or artificial energy is required to maintain the resonant energy flow it is recognized that for every energy application system a source and sink system must exist for the transformation of the potential energy into the desired form of useful work a heat engine will not function unless there is a heat sink available a hydro plant will not operate unless there is a lower level sink to accept the flow. For this RF ionospheric system there must be a reflector a receiving antenna and the all-important sink matched impedance resistive load.

An open or vacuum cavity resonator comprising a single atom-coupled waveguide can couple significant wattage right out of the air and can act as an electromagnetic sink that couples significant wattage right out of the ambient radiation field. It can do so even when the ambient field is quite feeble this type of circuit mimics atomic absorption and stimulated emission.

In order to utilize this high-voltage energy you must do two things, make an energy sink and then devise a way of making the sink oscillate such a sink has to be at a lower energy state than the surrounding medium and for the energy to continually flow into it, the energy must be continually pumped out of it additionally this sink must maintain a lower energy state while meeting the power requirements of the load attached to it.

A horn feed antenna and optical atom-coupled waveguide and ferrite choke and shading coil perform the function of a one way valve which serve to energize the RLC coil or loop antenna spark gap transmitter via a chain reaction of an atomic squeezed or hour-glass mode or by the Rabi splitting of the ZPE and after sufficient time the charge discharges across the spark gaps whereby the radio cavities the delta antenna and implosion propulsion dielectric materials are energized to a high potential twin plate capacitors exhibiting the vector and edge effect the extension of electric lines of force between the outer edges of capacitor plates because the lines of force are not confined to the space between the plates they can cause capacitive coupling with external bodies the radio cavities are in essence turbo charging diode amplifiers producing a beat frequency composed of ZPE and thus winding it up actually moving the EM energy through radial toroidal to axial rotation in other words a triune vortex implosion.

Selected to resonate in response to the incident primary electromagnetic radiation in order to produce secondary electromagnetic radiation at a second frequency at an enhanced energy density means for transmitting the emitted secondary electromagnetic radiation at the beat frequency conducted through a tandem set of reverse wave cavities energized via said tank circuit antenna comprising a spark gap transmitter converter inductively connected to a plurality of the impedance matching antenna transceiver system.

In general, the invention relates to the conversion of electromagnetic radiation but not by way of limitation atom, gamma, photon, light, RF, ZPE into electrical and implosion propulsion energy having both a push and a pull via the conversion of high frequency bandwidths contained within the cosmic spectrum known as the vacuum or ZPE fields.

Essentially the present invention utilizes an antenna array structure for receiving and transmitting incident electromagnetic radiation known to propagate through the vacuum of space or any other medium in which the receiving structures may be suitably located. The system of the present invention is specifically designed to convert but not by way of limitation the energy of atom, gamma, photon, light, ZPE or any other type of acoustic or electromagnetic energy.

The implosion propulsion receiving structures are composed of dielectric material in order to diffract and scatter the incident electromagnetic radiation. Additionally the receiving structures such as the optical atom coupled waveguide are of a volumetric size selected to enable the structures to resonate at the atomic transition frequency of the incident electromagnetic radiation or that of the Rabi frequency based on the parameters of frequency of the incident radiation and propagation characteristics of the medium and of the receiving antenna structures.

The system of the present invention also includes an antenna that receives the beat frequency radiation i.e. delta antenna receives the emitted reverse waves from the radio cavities however the emitted energy is returned to the system by way of for lack of a better term putting english on the wave energy thereby causing said energy to return into the antenna system and too be recycled thereby expand exponentially and approaches infinity.

The dielectric implosion propulsion plates are thus in the form of an array said pairs of the array are preferably positioned proximal to each other in order to maximize the amount of energy extracted from a particular area or space of a given size.

Herein as above and set forth the energy density of the zero point radiation increases as the frequency of the radiation increases it is desirable that the dielectric plates resonate at as high a bandwidth of frequencies as possible because the dielectric plates must be small in direct proportion to the wavelength of the high frequencies of the incident electromagnetic radiation at which resonance is desirably obtained a miniaturized system enhances the energy output capability of the system by enabling it to resonate at higher frequencies at which there are correspondingly higher energy densities consequently, utilization of an optical atom coupled antenna array in the system enhances the maximum amount of electrical energy provided by the system.

Accordingly, there has been provided, in accordance with the invention, a system which converts high frequency zero point electromagnetic radiation, atoms, light and/or any other type of incidental environmental energy into electrical energy and converting same to a superconductive implosion propulsion energy that is pull and push combined via vortex action effectively and efficiently and thus fully satisfies the objectives set forth above. It is to be understood that all terms used herein are descriptive rather than limiting. Although the invention has been specifically described with regard to the specific embodiments set forth herein, many alternative embodiments, modifications and variations including solid state components will be apparent to those skilled in the art in light of the disclosure set forth herein. Accordingly, it is intended to include all such alternatives, embodiments, modifications and variations or species embodied by this invention method that fall within the spirit and scope of the invention as set forth in the claims herein.

QED Inception and Lab Report

I began research in 1984 and did conceive on Dec. 15, 1994 an invention based on vortex mechanics composed of an electromagnetic implosion device and did merge electronics, antenna and turbo charging concepts together comprising a quantum electrodynamic implosion circuit and did begin construction of a prototype QED Implosion unit Jan. 1, 1999 and did complete a first static model of said QED Implosion unit composed thereof a hand-fabricated set of dielectric plates and a set of backward wave radio cavities comprising a coaxial magnetron tube proximal and tandem-ally disposed there on a suitable circuit board as of January 2000 and witnessed by Mark McDaniel residing in Wapanucka Okla. whereupon I discovered several design flaws as a result of my manufacturing and assembly techniques and began revamping said QED Implosion unit completing the revisions on Jan. 1, 2001 with the completion of my first optical atom coupled waveguide.

I documented and filed at least one petition seeking financial assistance via grant application to each of the Government agencies listed below:
(ZPower Corporation Arizona Nov. 29, 1999 “The Ultimate Heist Superconductivity”)
Contact letter to (Bill Clinton US President Jun. 20, 2000 “Superconductive Technologies”)
(DOE Jul. 16, 2000 “Ambient Temperature Superconductive Technologies”) (DARPA Feb. 5, 2001 BAA 01-21)
(DOD Apr. 2, 2001 “Vacuum Cohesion Vehicles”)
(Rolex Awards For Enterprise Jul. 29, 2002 11:29:42 AM “Reverse Engineering”).
   First Mock-Up 1999

I continued refining the QED Implosion system and technology as well as documenting my discoveries via photographic means and burning same onto CD storage diskettes 1999-2003.

I constructed a first parabolic dish antenna from a Chinese Wok a cooking utensil and fabricated a delta antenna and coil from a stiff piece of copper wire that I bent into the proper configuration comprising a delta antenna and feeder coils I constructed a tandem set of dielectric edge plate energized capacitors from 1/8 inch Plexiglas as the dielectric material and #40 aluminum flat stock laminated to a pair of 14-inch plates composed thereof dielectric material thus forming the plate capacitors with at least one surface or face of said plate comprising a triple-arc or a dome structure composed there of two sets of aluminum pie pans laminated and stacked one on top of the other consisting of a five inch diameter pie pan and the other a nine inch diameter aluminum pie pan this particular argument of shaping the dielectric plates was to facilitate the formation of a plasma vortex in the near and fields of the dielectric material compare with other such shaped electrodes.

I constructed a twin set of radio cavities using coffee cans as the base structure I constructed coaxial-anode structures that is the rectangular resonators by wrapping aluminum foil around a measuring stick one inch by one inch by four inches and made end caps on one end by folding the aluminum foil over and pressing it closed I made upper end caps from a pattern using pie pans as the stock material I cut and folded the material to make end caps for the resonators using a paper hole punch I punched cooling holes and RF apertures into and through the upper most sections of the coaxial-anode resonant structures the original cathode for this first model was made from aluminum soda cans from which I made internal reflectors by reversing the end caps of the soda cans.

Using a Plexiglas tube I separated the anode structures from the cathode with board stock from cereal boxes I cut retainer rings to hold the resonant cavity anodes apart from one another and used silicone to secure the assembly together and slid the anode assembly into the coffee cans I mocked-up the optical atom coupled waveguide with a salvaged section of horn feed and cavity resonator that I scavenged from surplus satellite dish systems using a pair of lenses from binoculars.

I formed a first set of lens apertures and mocked-up a first choke coil from a surplus alternator I salvaged from a junk car and I mocked-up a tank circuit using some stereo (Y) connectors that I purchased from the local radio surplus store I made a set of spark gap electrodes for my tank circuit out of ¾ inch steel bearings.

I became aware very early on that my invention would be capable of becoming a superconductive power source collectively energized via EM RF Atomic energy scavenged from the environment.

First Revision June 2000

I fabricated a tank circuit transmission line from a folded dipole antenna that I hand fabricated from an aluminum door seal it was at this juncture that I wove by hand a set of high voltage cables thus forming the HV transmission lines for the spark gap electrodes also I salvaged a set of HV adjustable mounting lugs and hand fabricated a set of brass spark gap electrodes that could now be adjusted by set screws I salvaged and attempted to use capacitors from discarded microwave ovens connected into the tank circuit also at this juncture in time I located and acquired equipment capable of radio detection consisting of an RF Frequency Counter Cat. #22-305 from Radio Shack and a Micranta AF and RF Transistorized Single Tracer and a Continuity Meter MC-1015B and began testing and receiving anomalous readings coming from the QED Implosion unit I did in fact detect and discover that the unit was resonant with the atomic transition frequency and built a sliding boom apparatus for both the optical waveguide as well as the shading coil still waiting for the ferrite beads to arrive in the mail to assemble the choke coil combination.

Second Revision Jan. 1, 2001

Circumspect to the realization that the dynamics at work in the environment is interchangeable with those of electronic components and their circuitry. That fluid dynamic concepts are equivalent and wholly interchangeable with those of the electromagnetic spectrum and insomuch as my designs dealt with the amplification of power I began the study of electronics infused with Vortex Mechanics including the scavenging concepts of fluid dynamics and turbo charging systems. Conceptualizing an electronic circuit equivalent in function to a Vortex-turbo-charging-unit for the express purpose of extracting usable power.

Now focused, I searched for electronic components best matching the turbo charging criteria. I found the magnetron tube to be the closest matching electronic device via similar function and shape; producing both radial and axial rotation, vortex formations being the key issue.

In other words they are synonymous, the magnetron tube functions in like manner as a turbo-charging unit, albeit electrical verses a mechanical and fluid medium I also came to the realization Jun. 4, 2003 while composing a rough draft of my patent application that a coaxial magnetron and radio cavity assembly may indeed function in a similar manner as an atom by comparison only.

I constructed a revised loop antenna tank circuit from copper tubing that I bought at a local supplier using my liquid propane (LP) tank as a jig I formed the copper tubing into a circular loop I fabricated a tunable butterfly capacitor form Plexiglas material and aluminum flat stock and bolted the assembly together with all-thread material and mounted the assembly together with the loop antenna using U-bolts I drilled holes into and through the circuit board and mounted the antenna tank circuit onto and through the holes cut into the circuit board there in the center of the boresight forming the antenna array I salvaged a 6 foot satellite dish antenna and mounted it to the circuit board with nuts and bolts located along the boresight of the array.

Mock-Up #3

I salvaged surplus magnetron tubes from several microwave ovens Mar. 14, 2002 11:00 AM. I mounted the magnetron tubes into my radio cavity assemblies and wired their leads into and forming a regenerative feedback loop and circuit in the form of strap lines disposed around the resonant cavity anode structures. I fabricated a ferrite bead choke comprising a deflection yoke coil and shading coil unit I constructed a delta antenna and spiral coil from % inch copper tubing and mounted the delta antenna there in the focal length of the dish antenna.

Mar. 9, 2003-12:26 PM

Coming full crucial I am now aware that there are at least three issues preventing the QED Implosion system from operating two issues exists in the optical atom coupled waveguide an issue that occurs there is the need for proper microwave lenses in order to couple a brad spectrum into the optical cavity waveguide and the second issue is the need for capacitive and inductive tuning screws to be located strategically within the maximum electric and magnetic lines of force to facilitate proper tuning of the waveguide and the third and final issue is the need to rebuild the backward wave coaxial radio cavities from nonmagnetic materials and using better fabrication techniques then those previously used actually replacing the aluminum resonator anodes with copper tubing ensuring a stable design that is capable of resonating at the proper frequencies and producing a beat frequency.

In summary, I have provided a conjoined marriage of technology which covers theory and practice across a wide range of disciplines for the extraction and amplification of environmental space energies comprising a superconductive electrical implosion propulsion system and from the foregoing it will be apparent that the present invention provides a novel renewable energy source and a superconductive quantum electrodynamic implosion propulsion and transportation system when married with the quantum electro dynamic implosion propulsion unit and the selective shape of the VCV and its ceramic compositions herein the article.

The present invention exploits the above principles in a novel manner to similarly achieve greater efficiencies, lift and propulsion for an aircraft. In particular, the present invention contemplates the establishment of a pressure gradient in air streaming through a hyperbolic vortex flow chamber formed through the fuselage of an aircraft to provide lift and propulsion for the aircraft.

The pressure gradient increases through the convergence zone and high to low pressure differences occur thereof so that a larger vacuum force is exerted on the floor or top sections of the main wing rather than on the roof or under-section of the wing-thereof the lift and suction-head formed by the convergence zone and swirl-vane built into the wing of the aircraft is the difference in these two forces. To this end, the chamber extends through the fuselage so that, as the aircraft is driven forwardly through the air, air enters and streams through said horizontal vortex flow chamber.

The use of vortex flow through a horizontal orifice, chamber or duct formed through the fuselage of an aircraft, as in a wing mounted externally of the fuselage, results in a number of benefits. A vortex generating lift system will generally result in a more compact aircraft or wing than can be constructed using conventional wings and the use of a hyperbolic convergence zone offers flexibility in the design of aircraft to meet varying purposes.

Since the shape of the exterior of an aircraft having a vortex generating lift system and hyperbolic convergence zone can remain fixed while the profile of the swirl-vane is changed, such change can be used to vary the performance characteristics of the aircraft so that the aircraft designer is given a design variation capability that will generally not be available where external wings only are used to lift the aircraft. That is, changes in performance can be accomplished by shaping structural members that provide the longitudinal camber of the floor and the effect of such shaping can be determined independently of other factors involved in the overall interaction of the aircraft with the air through which the aircraft will move.

Moreover, since the swirl-vane is within the fuselage of the main wing, an aircraft constructed in accordance with the present invention offers the capability of providing mechanisms for shaping the swirl-vanes or vortex generators in flight without affecting the structural integrity of the aircraft as might be the case were shaping attempted in a wing extending in cantilever fashion from the fuselage independently. In addition, the formation of lifting surfaces within said horizontal vortex flow permits a direct utilization for vacuum-cohesion purposes of air streams produced by vortex rotations, (normally thought of as parasitic drag induced by incorrect geometrical aircraft structures) now used to propel an aircraft so as to provide lift from the forward Ram-induction or forced vortex motion of the aircraft through the air. With lifting surfaces formed in an open horizontal vortex flow chamber, such streams can be diverted to provide lift and propulsion so that the aircraft can be flown at lower or higher speeds than would generally be the case for comparable aircraft having external wings alone, primarily due to the natural cooling effects and energy amplification caused by selective geometrical shaping of the wings.

This section below describes a species and alternative applications and embodiments as used in the present invention as a vortex generator FIG. 24 and also showing a vortex formation as used in the innovation; for use on planes, trains, boats, submersibles and vehicles of any type said invention is also applicable for use on surfboards as an implosion fin FIG. 24 and is also well suited for use as a fan blade comprising radial flow fan blades FIG. 25. Primarily the only aspect of the invention that changes is the application for which said invention is used however the overall geometric shape and function remain unchanged no matter if the invention is used as a wing a fan-blade a surfboard fin a spoiler a wing or the selective shape of a superconductor these are just applications to which the method or technology apply and the general shape and function do not change as described herein the article below as is above and is well known to persons in the art.

This section below relates to the present invention in a lab report and as a species embodiment configuring the present invention into a surfboard fin FIG. 8a and also showing a vortex formation as used in the innovation.

Conception and build date Feb. 2, 1997 4:36 PM Calif. I Robert A. Patterson (R.A.P.) did conceptualize and build a prototype consisting of three scaled down implosive vortex fins and one surfboard for use on surfboards by forming a pattern with paper board stock and hand laminating said pattern with glass cloth and resin I did build three implosion fins and mounted each to a scale sized surfboard I did test the design in a rectangular wave tank and through visual inspection and detection I discovered that the usually V-shaped antagonistic and parasitic wave front which adversely affects designs of usual configuration had effectively been reversed and eliminated and was now imploding via suction-head actually pulling in a forward manner on the entire surfboard as well as the implosion fins themselves said implosion fins may be mounted or otherwise attached to any type surfboard in the usual manner e.g. by hard glassing or any type of detachable or snap locking system commonly used in this industry.

This section below relates to the invention of the present innovation in a lab report and as a species embodiment comprising a radial implosion fan configured from the present invention FIG. 25.

Date of conception Feb. 2, 1997 4:36 PM Calif. and build date Mar. 31, 1999 I R.A.P. did conceptualize and build a prototype radial implosion fan I built up a first model composed of ten blades by forming a pattern from paper board stock and hand laminating said pattern with glass cloth and resin on the date in question which was not intended for testing I built up a second implosion fan with twelve fan blades using epoxy resin in like manner and mounted each to a suitable hub thus forming an assembly resembling a fan and attached the assembly by set screw to a 12v electric motor capable of at least ten thousand RPM during the preliminary testing seven of the fan blades violently broke loose from the hub assembly and were flung outwardly from the assembly said fan assembly destroyed itself because the epoxy resin had not fully cured and thus was not strong enough to withstand the ten thousand RPM test I built a third and final model Feb. 23, 1997 composed of only ten implosion blades but no further test have been conducted with this species embodiment thereof the present invention.

This section below relates to the aforementioned invention as a species embodiment configuring the present invention into a superconductor composed thereof a ceramic composition FIG. 17 see also detailed description.

This section below relates to the aforementioned invention in a lab report and as a species embodiment configuring a wing of the present invention into a ram induction spoiler for the express purpose of increasing fuel efficiencies of vehicles applying a species version of said means to extract from an atmospheric environment useable inductive wing-tip vortex energy disposed there within a horizontal and hyperbolic amplification flow chamber FIGS. 17-22 and 10.

Lab Report

Ram Implosion Vortex Generating Systems.

Amplification and Extraction of Environmental Energies

Purpose: Increase Fuel Efficiencies.

Materials: Vortex Generator made of Styrofoam and hand lamination glass resin.

Procedure: Test Drive.

Data: Preliminary test dates Mar. 31, 2000. Secondary test date Oct. 15, 2002.

Approximate weight of the wing is 76 pounds.

Results: Mar. 31, 2002. 26-mile round trip at 65 MPH resulted in a 25% increase noted in fuel efficiencies. Oct. 15, 2002 100-mile test run at 70 MPH resulted in 34.16-MPG verses the 18-MPG normally consumed by the test vehicle thereby resulting in an increase in fuel efficiencies of 50%.

Error Sources: No wind tunnel testing available.

Conclusion: Advances in design plus lighter weight materials may yield even greater fuel efficiencies.

Purpose: To increase fuel efficiency by applying techniques known as aerodynamic drafting. Actually gaining and/or extracting useful work from the amplification of wing tip vortices i.e. shock waves, (the differential pressures between that of high and low pressures, which cause vortex formations to occur, selectivity). Usual wings or spoilers are designed with only one purpose in mind.

Which is to create a jet-stream of air pressure intended to brake-up air turbulence by ejection and/or pushing away vortex eddy currents which produce drag via trailing elastically along behind any vehicle in travel through the medium of air or fluids. Otherwise usual spoilers are intended only for their aesthetic appeal, ultimately possessing no practical or purposeful function. It should be noted that the use of a jet-stream concept is indicative of a brute force concept at best. A concept that only employs only half of the available energy contained within the elasticity of the atmospheric medium.

Embodied within the scope of the present invention is an added and second hybrid dimension. Whereby a powerful multi-cyclonic vortex or suction-head is caused to occur (via a selectively designed vortex generating system) preceding and/or selectively placed ahead of the ejection or jet stream thereby effectively coupling both the push and the pull energies inherent within the fluid dynamics of the atmospheric medium. Said vortex generator or implosion spoiler consists of a strategically designed and elliptically swept forward set of wings. Said wings are routed through hyperbolic curvatures (for the purpose of causing the viscosity or elasticity of the atmospheric fluid to hug a curve against its own centrifugal forces) and in combination with a swirl or vortex-generating vane disposed there in a horizontal vortex amplification chamber.

Said vortex swirl-vanes are designed and placed at the ends or tips of the elliptically swept forward i.e. hyperbolic vortex amplification chamber. For the express purpose of converging higher pressure air from under the wing and too pre-rotate it over to the lower pressures existing on the top surface of the wing. Whereby the rotation of air is selectively and strategically transformed into a multi-cyclonic vortex and suction-head, thus effectively reversing the parasitic effects caused by drag into a working energy transference and ultimately into greater fuel efficiencies when applied as a vortex generator, wing, fin etc. to any type of vehicle including electrically driven. Said vortex generator effectively eliminates parasitic drag, i.e., on a truck or any other type of vehicle wherever the ram implosion wing or vortex generator is affixed to a vehicle via mounting with standard nut, bolt, torque procedures applicable within the automotive industry.

Materials:

Vortex Generator Wing mounted with any suitable type of nut and bolt fasteners. 1 Vehicle e.g., Truck.

Procedure: Test drive said vortex-generating system mounted and affixed to a motor vehicle, e.g. a truck. A test run consisting of a 1 00-mile distance without the vortex-generating spoiler and once again with the vortex generating system. We will demonstrate how the design of a ram implosion vortex generating system” will create a centripetal vacuum or suction-head as well as a tangential vortex force. Which will detract from the overall parasitic drag that is created by this or any other vehicle in motion while traveling through the air and thereby translate said suction-head into greater fuel efficiencies.

Data: The forces acting on the truck are in the form of a suction-head FIG. 10 (V) actually pulling backward on the vehicle in an antagonistic manner (B). As the vehicle travels through the air it produces a horizontal and counter clock-rotating wave due to the incorrect adherence to wave geometry (A). At first this horizontal waveform moves out in front of the vehicle. However, as the truck begins to move faster the air becomes stretched elasticity, similar to a rubber band stretched between two-post (B). As the truck gains speed the horizontal wavefront bends backward thereby forming a parasitic vortex (V).

Odometer: Difference: MPG w/o Odometer: MPG with 100 miles.

162687.2 162787.4.

Results: MPG w/o the wing 18 MPG w/wing 34.16.

Drafting is a technique familiar to motorist that venture to close behind big-rig trucks as they encounter the buffeting effects FIG. 26(A) of the horizontal vortex wavefront which is now pulling their vehicle along forward with the vortex motion that is parasitically generated-by the forward travel of the big-rig truck through the viscous elasticity of the air.

Oct. 15, 2002-6:05 PM

I fashioned with all-thread and fastened a wing as disclosed herein onto the side rails of a truck thus forming an inductive or implosive spoiler and did depart from Coleman Okla. this morning Oct. 15, 2002 at 8:15 AM with a full tank of gas toped off so that gas was pooling at the intake nozzle. In other words the tank was completely full and could store no more.

At the start of the trip the odometer read 162687.2. I then proceeded to drive a 100-mile distance with an average speed of 70 MPH to 12958 Coit RD. Dallas Tex. With the Vortex Gen. System functioning and attached to the vehicle owned by Mark McDaniel a 1994 Chevy S-10 Extended Cab 4.3 Liter V-6 Average gas mileage before the test was between 18-20 MPG. Upon arriving I pulled into the FINA gas station on Coit RD. and once again I toped off the tank so that it was completely full.

The odometer now read 162787.4 a distance of 100-miles and 5 tenths. Attaching the Vortex Gen. System to the vehicle translated into 34.16 MPG effectively doubling the mileage of this vehicle.

| | |
|---|---|
| Witness: Mark McDaniel | Inventor: Robert A. Patterson |
| Coleman, Oklahoma. | |
| Oct. 16, 2002 | Oct. 15, 2002 |
| 1:13 PM | 7:03 PM |

Error Sources: Inability to accurately measure the volumetric vacuum forces generated via the ram implosion vortex spoiler, fin, wing generating system. Due primarily to the lack of wind tunnel or other such test equipment to measure pneumatic differential pressures.

Conclusion: Combining aerodynamic principles with those of turbo charging and/or vortex mechanics. Into the form of a ram implosion vortex generating system our spoiler design resulted in and demonstrated an overall increase in fuel efficiency by a margin of 25% to 50% increases for any vehicle fitted with the ram implosion vortex generating system.

The centrally located centripetal vacuum created by the wing subtracted from the overall parasitic drag of the vehicle. Resulting in the increased efficiencies and overall reduced drag. The quantity of fuel conserved during preliminary testing factored into a (0.5) gallon decrees in fuel consumption. However the secondary test demonstrated a savings of half the fuel normally expended to over come the drag created by the vehicles motion through the air. This means that less fuel was expended to overcome the drag of the vehicle. Thereby translating into savings of fuel and/or dollar-wise the more miles traveled while using the vortex generating system (VGS).

Vortex Generator Environmental Energy Amplifier FIGS. 17-22

Date of conception Jan. 22, 1997 11:PM Nevada.

Construction began: Thursday Jan. 23, 1997 4:15 PM.

Construction completed approximately Mar. 1, 2000 dimension 6′6″ six feet six inches across left to right and 3′ three feet in depth front to back.

Lab Repot and Thoughts in General May 1, 2002

Present marketing strategy based on my findings thus far a 25% savings in fuel cost to the consumer and a 50% savings in fuel as of 10/15/20.

I have developed an actual test model; the drawbacks were excessive weight of the first unit. Develop light weight versions add diffusion pattern for the purpose of pulling a higher state of vacuum and reduced in size enabling its use on smaller compact cars so that they may enjoy the same fuel savings as any larger sized vehicle.

Jun. 11, 2002

I have come to the conclusion that either a mold has to be built, but that is rather involved and expensive so the only other alternative for a good test model may be to get some foam and shape the wing by hand similar to making a surfboard so that it turns out light weight vs. the heavier construction as in the first version.

Diffusion cells similar to waffle shaped patterns the main idea is to eliminate laminar flow in favor of producing more vacuum.

Jun. 12, 2002

Lightened the wing by removing excess material.

Jun. 23, 2002

Discovered wing wicking up water facilitated repairs.

Lightened the wing by removing excess material.

While particular embodiments of the present invention have been shown and described, it would be obvious to those skilled in the art that changes and modifications may be made without departing from this invention in its broader aspects. Therefore, appended claims are to encompass within their scope all such changes and modifications as fall within the true spirit and scope of this invention method or species embodied by this invention method.

A method of manufacturing the invention comprising the following steps:

Resin transfer molding (RTM) may be adopted for the fabrication process of the aircraft. The raw materials required for fabrication of the wing include selective composition of ceramic material, Kevlar, glass fiber, carbon fiber in various forms such as chopped strand mat, cloth surface mat, woven roving & resin (epoxy & polyester), hardener, catalysts, accelerator, pigments, surface treatment agents etc. Or Hand-shaped Styrofoam construction, hand laminated similar to surfboard building, injection molding or by any other method including metallurgy that is common, standard or otherwise accepted manufacturing practices used or applicable within the aircraft or superconductor industries. All the basic raw materials required for fabricating are available indigenously.

1. A system for coupling at least one atom and at least one hour-glass mode and converting quantum electrodynamic vacuum cavity fluctuations electromagnetic radiation energy to electrical and to a superconductive vortex implosion propulsion energy comprising;
a first means for receiving incident primary electromagnetic radiation, said means for receiving and producing emitted secondary electromagnetic radiation at a first frequency, said first means for receiving having a first volumetric size selected to resonate at a frequency within the frequency spectrum of the atomic transition frequency of said primary electromagnetic radiation in order to produce the secondary electromagnetic radiation at the first frequency at an enhanced energy density;
a second means for receiving and guiding the incident primary electromagnetic radiation, said means for receiving producing emitted secondary electromagnetic radiation at a second frequency, the secondary radiation at the first frequency and the secondary radiation at the second frequency interfering to produce secondary radiation at a lower frequency than that of the incident primary radiation, said second means for receiving having a second volumetric size selected to resonate at a frequency within the frequency spectrum of the incident primary electromagnetic radiation in order to produce the emitted secondary electromagnetic radiation at the second frequency at an enhanced energy density;
a third means an antenna for receiving the emitted secondary electromagnetic radiation at the lower frequency, said antenna providing an electrical output via spark gap transmission responsive to the secondary electromagnetic radiation received,
a spark gap emitter electrically connected to said antenna for receiving electrical current output from said antenna and converting the electrical current output to electrical current discharge at a higher energy density having a desired voltage and waveform.
a forth means for receiving and amplifying the emitted secondary electromagnetic radiation at a higher energy density a tandem set of backward wave radio cavities having a desired voltage and waveform;
a fifth means composed of dielectric materials for receiving the emitted secondary electromagnetic radiation selectively and proximal to each other and which receive incident electromagnetic radiation at a higher energy density for coupling with external bodies thereby comprising an implosive propulsion system; and
a sixth means for receiving the emitted secondary electromagnetic radiation at a higher energy density but not by way of limitation a hyperbolic dish and delta antenna and a reverse wave energy having a desired voltage and waveform byway of reflection or english on the emitted waves such that at least a portion of the energy returns into the system simultaneously.

2. The system of claim 1 wherein:
said first means for inductively receiving and transmitting the emitted secondary electromagnetic radiation is composed of a resonant cavity atom coupled optical waveguide of usual material;
said second means for inductively receiving and transmitting the emitted secondary electromagnetic radiation is composed thereof a predetermined composition comprising a ferrite bead choke and deflection yoke coil and a set of spark gap electrodes comprising a safety spark gap electrode system selectively and strategically disposed around the perimeter of said coil also composed of a shading coil comprising a one way valve;
said third means for inductively receiving and transmitting the emitted secondary electromagnetic radiation is composed of but not by way of limitation a loop antenna tank circuit lumped transmission line spark gap transmitter,
said forth means for inductively receiving and transmitting and amplifying a beat frequency of the emitted secondary electromagnetic radiation is composed of a set of tandem reverse backward wave radio cavity oscillators;
said fifth means for inductively receiving and transmitting the emitted secondary electromagnetic radiation is composed of a twin set of dielectric materials there disposed strategically adjacent to said reverse backward radio cavity oscillators; and
said sixth means for inductively receiving and transmitting the emitted secondary electromagnetic radiation and transmitting same but not by way of limitation comprising a delta antenna of predetermined geometry a tandem set of pancake or archimedes spiral coils a hyperbolic dish comprising an antenna array.

3. The system of claim 1 wherein:
said first means for receiving is an atom coupled optical waveguide antenna structure comprising a predetermined configuration of apertures grounding wings,
said second means for receiving is a ferrite bead choke coil and safety spark gap system;
said third means for receiving is a loop antenna lumped transmission line tank circuit spark gap transmitter;
said forth means for receiving is a tandem set of reverse wave oscillating cavities;
said fifth means for receiving is a tandem set of dielectric materials; and
said sixth means for receiving is a delta antenna coil and hyperbolic dish antenna.

4. A system for converting incident quantum electrodynamic cavity vacuum fluctuations or zero point electromagnetic radiation energy to electrical and implosion propulsion energy, comprising:
a first means for transmitting for receiving incident primary zero point electromagnetic radiation, said means for receiving producing emitted secondary electromagnetic radiation at a first frequency;
a second means for transmitting for receiving the incident primary zero point electromagnetic radiation, said means for receiving producing emitted secondary electromagnetic radiation at a second frequency, the secondary radiation at the first frequency and the secondary radiation at the second frequency; the secondary radiation at the first frequency and the secondary radiation at the second frequency ringing or interfering to produce secondary radiation at a greater energy density which is greater than that of the incident primary radiation;
an antenna for transmitting for receiving the emitted secondary electromagnetic radiation at the greater frequency or energy density, said antenna providing an electrical output and input responsive to the secondary electromagnetic radiation received;
means for transmitting for receiving the emitted secondary electromagnetic radiation at the beat frequency from said antenna, said means for transmitting inductively connected to said antenna; and
a means for transmitting for receiving the emitted secondary electromagnetic radiation at the beat frequency from said antenna and converting the same to electrical RF or electromagnetic current having a desired voltage and waveform means for transmitting for receiving emitted secondary electromagnetic radiation at the beat frequency from said antenna and converting same to electrical RF or electromagnetic current having a desired voltage and waveform.

5. The system of claim 4 wherein: said first means for receiving has a first second third forth fifth and sixth volumetric size selected to resonate in response to the incident primary or atomic transition frequency electromagnetic radiation in order to produce the secondary electromagnetic radiation at the first frequency at an enhanced energy density; and
said second third forth fifth sixth seventh eight and ninth means for receiving have their own second volumetric sizes which are selected to resonate in response to the incident primary electromagnetic radiation in order to produce emitted secondary electromagnetic radiation at the second through the ninth frequency at an enhanced energy density, said first second third forth fifth sixth seventh eight and ninth volumetric sizes selected based on parameters of propagation constant of said first second third forth fifth sixth seventh eight and ninth means for receiving, propagation constant of medium in which said first through said ninth means for receiving are located and frequency of the incident primary electromagnetic radiation.

6. The system of claim 5 wherein: the structure of the first means for receiving is different from the structure of the second third forth fifth sixth seventh eight and ninth means for receiving, difference between the structure of said first means for receiving and the structure of said second means for receiving selected so that the beat frequency resulting from the difference is a frequency which facilitates conversion of the beat frequency electromagnetic radiation RF at an enhanced energy density which energizes the third means for receiving and is different from the structure of the second and different from the structure of the first means for receiving and said third means energizing the forth and fifth structures volumetric sizes selected based on parameters of propagation constant of said first second third forth fifth sixth seventh eight and ninth means for receiving, propagation constant of medium in which said first through said ninth means for receiving are located and frequency of the incident primary electromagnetic radiation;
wherein the structure of the forth and fifth means for receiving are different from the structure of the first second third and sixth seventh eight and ninth means for receiving, difference between the structure of said forth and fifth means for receiving and the structure of said second third means for receiving selected so that the beat frequency resulting from the difference is a frequency which facilitates conversion of the beat frequency electromagnetic radiation RF at an enhanced energy density which energizes the sixth and seventh means for receiving is different from the structure of the first second third forth fifth eight and ninth and different from the structure of the first second third forth and seventh eight and ninth means for receiving volumetric sizes selected based on parameters of propagation constant of said first second third forth fifth sixth seventh eight and ninth means for receiving, propagation constant of medium in which said first through said ninth means for receiving are located and frequency of the incident primary electromagnetic radiation; wherein the structure of the sixth and seventh means for receiving are different from the structure of the first second third forth fifth and eight and ninth means for receiving, difference between the structure of said sixth and seventh means for receiving and the structure of said first second third forth and fifth means for receiving selected so that the beat frequency resulting from the difference is a frequency which facilitates conversion of the beat frequency electromagnetic radiation RF at an enhanced energy density which energizes the eight and ninth means for receiving is different from the structure of the first second third forth fifth sixth seventh and different from the structure of the first second third forth fifth sixth and seventh means for receiving volumetric sizes selected based on parameters of propagation constant of said first second third forth fifth sixth seventh eight and ninth means for receiving, propagation constant of medium in which said first through said ninth means for receiving are located and frequency of the incident primary electromagnetic radiation; and
wherein the structure of the eight and ninth means for receiving are different from the structure of the first second third forth fifth sixth seventh means for receiving, difference between the structure of said sixth and seventh means for receiving and the structure of said first second third forth and fifth and sixth and seventh means for receiving selected so that the beat frequency resulting from the difference is a frequency which facilitates conversion of the beat frequency electromagnetic radiation RF at an enhanced energy density which energizes the eight and ninth means for receiving is different from the structure of the first second third forth fifth sixth seventh eight and different from the structure of the first second third forth and seventh eight and ninth means volumetric sizes selected based on parameters of propagation constant of said first second third forth fifth sixth seventh eight and ninth means for receiving, propagation constant of medium in which said first through said ninth means for receiving are located and frequency of the incident primary electromagnetic radiation for receiving and conversion to electrical implosive propulsion energy.

7. The system of claim 4 wherein:
said first means for receiving for transmitting is composed of a waveguide optical coupled atom cavity displaying a frequency-dependent photon-mode density;
said second means for receiving for transmitting is composed of a ferrite material and coil and safety gap electrodes;
said third means for receiving for transmitting is composed of a lumped element antenna tank circuit;
said forth means for receiving for transmitting is composed of a twin tandem pair of reverse backward wave oscillating cavities;
said fifth means for receiving for transmitting is composed of a twin tandem pair of dielectric materials; and
said sixth means for receiving for transmitting is composed of a hyperbolic dish and delta antenna coil.

8. The system of claim 4 wherein:
said first means for receiving is generally elliptical;
said second means for receiving is circular;
said third means for receiving is circular;
said forth means for receiving is cylindrical;
said fifth means for receiving is cylindrical;
said sixth means for receiving is circular;
said seventh means for receiving is circular;
said eight means for receiving is paraboloid; and
said ninth means for receiving is triangular.

9. The system of claim 4 wherein said atom coupled optical waveguide antenna displaying a frequency-dependent photon-mode density is positioned generally end to end comprising a bore-sight between said first, second, third, forth, eight and ninth receiving structures and forming delta-T drift region between said forth fifth sixth and seventh means for receiving.

10. The system of claim 4 wherein said antenna system is an antenna array.

11. The system of claim 4 wherein said antenna is a generally convex shell partially enclosing said first means for receiving.

12. The system of claim 4 wherein said means for transmitting is a system comprising an antenna array and tank circuit arc.

13. A system for converting incident quantum electro dynamic zero point electromagnetic radiation energy to electrical implosion propulsion energy comprising:
a plurality of pairs a first through ninth means for receiving for transmitting incident quantum electro dynamic primary zero point electromagnetic radiation and second means for receiving incident primary zero point electromagnetic radiation, a third forth fifth sixth seventh eight and ninth plurality of pairs of means for receiving transmitting amplification said first means for receiving producing emitted secondary electromagnetic radiation at a first frequency, said second means for receiving the incident primary zero point electromagnetic radiation producing emitted secondary electromagnetic radiation at a second frequency, the secondary radiation at the first frequency and the secondary radiation at the second third forth fifth and sixth and seventh eight and ninth frequency interfering to produce secondary radiation at a beat frequency which is higher than that of the incident primary radiation, said first means for receiving having a first volumetric size selected to resonate in response to the incident primary electromagnetic radiation in order to produce the secondary electromagnetic radiation at the first frequency at an enhanced energy density, and said second means for receiving having a second volumetric size selected to resonate in response to the incident primary electromagnetic radiation in order to produce the emitted secondary electromagnetic radiation at the second third forth fifth sixth seventh eight and ninth frequency at an enhanced energy density, said first second third forth fifth and sixth seventh eight and ninth volumetric sizes selected based on parameters of propagation constant of said first second third forth fifth sixth seventh eight and ninth means for receiving, propagation constant of medium in which said first through ninth means for receiving are located and frequency of the incident primary electromagnetic radiation, said first second third forth fifth sixth seventh eight and ninth volumetric sizes being different from each other;
a plurality of antennas for receiving the emitted secondary electromagnetic radiation at either a lower or higher frequency, said antenna providing an output responsive to the secondary electromagnetic radiation received, each of said plurality of antennas receiving the emitted secondary electromagnetic radiation of one of said pairs of first, second, third, forth, fifth sixth seventh eight and ninth means for receiving;
means for transmitting the emitted secondary electromagnetic radiation at the beat frequency from said antenna, said means for transmitting inductively connected by boresight and or drift region to said plurality of antennas; and
a converter inductively connected via RF at a higher energy density to said means for transmitting for receiving the emitted secondary electromagnetic radiation at the beat frequency from said antenna array system and converting same to electrical current having a desired voltage and waveform and collectively energizing said forth fifth sixth seventh eight and ninth antenna structure via boresight and drift region converting same to an implosive propulsion energy.

14. In an externally winged craft having a fuselage and means for providing lift and propulsion for the aircraft, the improvement wherein an internally disposed swirl vane that is a wing within a wing essentially unobstructed within a substantially horizontal hyperbolic egg-shaped vortex amplification chamber or opening disposed in a rotational convergence zone extending through the main wing structure forms said propulsion that is a suction-head or vortex flow such that the hyperbolic swirl chamber or vortex generator, a swirl-vane forms said means for providing lift and propulsion and a means for cooling the aircraft by producing a thermoacoustic cooling effect thereby setting into motion a refrigerated effect which may occur by the compression and expansion of atmospheric gas for the aircraft and provide an internal wing chamber and swirl vane or wing within a wing thereof, wherein the fuselage has opposed forward, lateral and rear ends intersected by said hyperbolic vortex chamber disposed within said vortex convergence zone such that the passage or input element opens forward, and through the upper and lower surfaces of the aircraft's main wing structure wherein the architecture of the wing characterized as being formed by a single portion of the wing and strategically positioned vortex swirl-vane beginning in the optimal tangent point disposed in the convergence zone of the hyperbolic egg-shaped chamber or labyrinth located within the main wing structure.

15. The aircraft and invention of claim 1 further comprising propulsion means for forming a at least a portion of a rearward directed air stream in addition a preferred and improved use of environmental energy thereby forming a vortex flow or suction head so as to propel the aircraft; and means for directing a greater portion of the air stream passing through said hyperbolic chamber and vortex convergence zone whereby the aircraft is propelled forward by the Implosion that is a vacuum, vortex flow or suction head and thereby causing thermoacoustic cooling of the craft by compression and expansion of gases.

16. The invention and aircraft of claim 2 wherein the means for directing at least a portion of said air stream through the selectively shaped hyperbolic shaped horizontal vortex flow chamber comprises: means forming a tangential zone in portions of the fuselage underlying the section of the wing that is open to the environment that is said horizontal vortex flow chamber near the forward end of the aircraft communicating with the vortex flow through the horizontal orifice and input elements and main wing sections through a horizontal orifice formed in the floor of the lifting wing and extending through the wing to the upper most surface thereby forming a hyperbolic vortex chamber and means for diverting at least a portion of said air stream into the tangential zone giving rise to a pressure gradient in the air stream's convergence zone, which result in the formation of thermoacoustic cooling.

17. The invention or aircraft of claim 1 wherein the vortex generator comprises a transverse flap forming a portion of the main wing section adjacent the forward end of the aircraft, said flap pivotally connected at the side thereof nearest the beginning of the hyperbolic vortex chamber of the fuselage hinged about a transverse axis; and means for pivoting said flap.

18. The aircraft and invention of claim 1 wherein the hyperbolic vortex chamber and vortex generator has a first portion extending longitudinally along one side of the vortex generator lifting wing-let or swirl-vane and a second portion extending longitudinally along the opposite side of the ellipsoidal egg-shaped hyperbolic vortex chamber, the first and second portions of the hyperbolic chamber meeting at a negative dihedral at the center of the hyperbolic vortex flow chambered vortex generator.

19. The aircraft of claim 1 wherein portions of the fuselage forming the hyperbolic chamber of the vortex generator at the front-end of the aircraft are formed into two transversely extending, pivotable flaps and portions of the fuselage forming the vortex generators and hyperbolic chambers at the front-end of the aircraft and disposed therein the vortex generators are formed into two transversely extending, pivotable flaps so as to provide pitch and roll control for the aircraft.

20. The aircraft of claim 1 further comprising a plurality of horizontally extending internal rudders pivotally mounted within the hyperbolic vortex chamber near the front-end of the aircraft's main wing affixed to the swirl-vane vortex generators.

21. The aircraft of claim 7 wherein portions of the fuselage forming sides of the hyperbolic chamber or convergence zone at the forward end of the fuselage are formed into horizontally extending flaps pivotable about the leading edges of the swirl-vanes, vortex generating wing-lets thereof laterally outwardly from the fuselage.
